(19) United States
(12) Patent Application Publication
(10) Pub. No.: US 2005/0231648 A1
(43) Pub. Date: Oct. 20, 2005

(54) Apparatus and method for processing image

(76) Inventors: Yuki Kitamura, Tokyo (JP); Ayumi Mizobuchi, Tokyo (JP); Tamao Katayama, Tokyo (JP); Mami Uchida, Saitama (JP)

Correspondence Address: William S. Frommer, Esq.;FROMMER LAWRENCE & HAUG LLP, 745 Fifth Avenue, New York, NY, 10151, US

(21) Appl. No.: 11/009,232

(22) Filed: Dec. 10, 2004

(30) Foreign Application Priority Data
Dec. 12, 2003 (JP) 2003-414115

(51) Int. Cl. H04N 5/44

(52) U.S. Cl. 348/734; 348/564

(57) ABSTRACT

When a remote-control signal reception portion receives an input to direct take-in of an image, a capture-processing portion captures, if the input to direct the take-in is received through the receiving device, an image signal that forms the display image to be displayed on the display portion as digital data. The digital data is stored in an external memory. In this case, a reduced image of an image corresponding to the currently captured digital data and at least one reduced image of the images corresponding to digital data captured in the memory in the past are displayed for a predetermined lapse of time at a predetermined display region in one portion on a display screen. The captured images may be respectively displayed and character-recognized character information contained in the displayed image as display information may be also utilized.

### BACKGROUND OF THE INVENTION

1. Field of the Invention

The present invention relates to an apparatus and a method for processing an image. More particularly, it relates to a variety of an apparatus and a method for processing an image signal (video signal) of a reproducer or a recorder/reproducer of, for example, a monitor receiver such as a TV receiver, a video tape recorder (VCR), or a digital versatile disc (DVD).

2. Description of Related Art

There has been provided electronic equipment such as a display device provided with a so-called capture function to take in an image (video) displayed on a display screen as digital data (image data) and save it in an image file so that it can be viewed or analyzed. For example, disclosed has been a technology for capturing an image displayed on a display screen while viewing it in a TV broadcast program and displaying the image on a sub screen formed at a portion of the display screen so that it can be watched while continuously watching a video of the TV broadcast program as displayed on the display screen (see Japanese Patent Application Publication No. 2002-44544).

Further, also disclosed has been a technology for recognizing characters in displayed character information such as a telephone number, an e-mail address, or a uniform resource location (URL) contained in a captured image to automatically make a phone call by using the character-recognized telephone number, transmit a created e-mail to the character-recognized e-mail address as a transmission destination, or access a Web page identified by the character-recognized URL to acquire information (see Japanese Patent Application Publication No. 2002-44544).

According to these technologies, it is possible for a viewer to surely hold necessary information and utilize it without taking notes, in a hurry, of a telephone number displayed in a TV shopping program, an e-mail address displayed in a TV broadcast program to which an opinion or an impression is to be sent, a URL of a Web page that provides detailed information, and the like.

It is to be noted that an image a viewer wish to capture is not limited to such the captured image containing character information that indicates a communication partner (i.e. a communication destination or party) such as a telephone number, an e-mail address, or a URL. For example, a viewer may sometimes wish to serially capture videos over a plurality of number of times in a relatively short time such as cooking recipes displayed in a cooking program in a plurality of number of times or words displayed as a musical composition is performed in a song program. In such a case, it is rare for the captured images to be immediately used but it is often that the images may be viewed as necessary.

In the case of the above-described technologies, a captured image can be displayed on a sub screen immediately, so that it is convenient when one captured image is used immediately. However, if images are captured serially in a relatively short time in a plurality of number of times as in the case of the above-described cooking recipe, only one captured images can be displayed on the sub screen at a time, so that it may not in some cases accommodate such a case that it is necessary to know whether a plurality of images of interest can be captured or properly use a plurality of images captured serially, depending on purposes.

From the above, it is an object of the present invention to provide an easy-to-use apparatus provided with a display image take-in function (capture function) and a method used in the apparatus.

### SUMMARY OF THE INVENTION

According to an aspect of the invention, there provides an apparatus for processing an image. The apparatus comprises receiving device for receiving an input to direct take-in of the image displayed on a display screen. The apparatus also comprises take-in device for, if the input to direct the take-in is received through the receiving device, taking in as digital data in a memory an image signal that forms the image of one frame displayed on the display screen. The apparatus further comprises display-processing device for, if the digital data is recorded in the memory, processing a display of a reduced image of an image corresponding to the currently recorded digital data and at least one reduced image of an image corresponding to the digital data recorded in the memory in the past for a predetermined lapse of time at one portion on the display screen.

According to another aspect of the invention, there provides a method for processing an image. The method comprises a reception step of receiving an input to direct take-in of the image displayed on a display screen. The method also comprises a take-in step of, if the input to direct the take-in is received at the reception step, taking in as digital data in a memory an image signal that forms the image of one frame displayed on the display screen. The method further comprises a display-processing step of, if the digital data is recorded in the memory, displaying for a predetermined lapse of time a reduced image of an image corresponding to the currently recorded digital data and at least one reduced image of an image corresponding to the digital data recorded in the memory in the past, at one portion on the display screen.

According to the present invention, when an image take-in direction is received by the receiving device, an image signal that forms a display image is taken in by take-in device as digital data and recorded in a predetermined memory. Then, a reduced image of the image corresponding to the digital data thus currently recorded in the predetermined memory and at least one reduced image of images corresponding to digital data recorded in the past in this predetermined memory are displayed for a constant lapse of time in a predetermined display region in a portion of a display screen. That is, if the images are to be taken in, the respective reduced image of the currently taken image and at least one reduced image of the images taken in the past are simultaneously displayed in the predetermined area of the display screen for a constant lapse of time.

In such a manner, if the display images are to be taken in, the reduced image of the image currently taken and that of the image taken in the past are displayed, so that it is possible to confirm that the image to be currently taken in has been taken in surely and also that there is an image taken in the past. Further, if the display images are to be taken in serially, it is possible to confirm continuity of the images to be taken in. That is, an easy-to-use apparatus for processing an image is realized that is provided with an image take-in function.

According to further aspect of the invention, there provides an apparatus for processing an image. The apparatus comprises receiving device for receiving an input to direct take-in of the image displayed on a display screen. The apparatus also comprises take-in device for, if the input to direct the take-in is received through the receiving device, taking in as digital data in a memory an image signal that forms the image of one frame displayed on the display screen. The apparatus further comprises display-processing device for, if the digital data is recorded in the memory, displaying a reduced image of an image corresponding to the currently recorded digital data and at least one reduced image of an image corresponding to the digital data recorded in the memory in the past at one portion on the display screen. The apparatus additionally comprises selection-input-receiving device for receiving an input of selecting a target reduced image from those reduced images that are displayed by the display-processing device. The apparatus still-further comprises character recognition device for recognizing character information displayed in the target reduced image that is selected through the selection-input-receiving device. The apparatus further comprises communication-related processing device for performing communication-related processing in accordance with the character information recognized by the character recognition device if this character information indicates a communication partner.

According to still-further aspect of the invention, there provides a method for processing an image. The method comprises a reception step of receiving an input to direct take-in of the image displayed on a display screen. The method also comprises a take-in step of, if the input to direct the take-in is received at the reception step, taking in as digital data in a memory an image signal that forms the image of one frame displayed on the display screen. The method further comprises a display-processing step of, if the digital data is recorded in the memory, displaying a reduced image of an image corresponding to the currently recorded digital data and at least one reduced image of an image corresponding to the digital data recorded in the memory in the past, at one portion on the display screen. The method additionally comprises a selection-input-receiving step of receiving an input of selecting a target reduced image from those reduced images that are displayed at the display-processing step. The method still-further comprises a character recognition step of recognizing character information displayed in the target reduced image that is selected at the selection-input-receiving step. The method further comprises a communication-related processing step of performing communication-related processing in accordance with character information recognized at the character recognition step if this character information indicates a communication partner.

According to the present invention, when an image take-in direction is received by receiving device, an image signal that forms a display image is taken in by take-in device as digital data and recorded in a predetermined memory. Then, a reduced image of the image corresponding to the digital data thus currently recorded in the predetermined memory and at least one reduced image of images corresponding to digital data recorded in the past in this predetermined memory are displayed for a constant lapse of time in a predetermined display region in a portion of a display screen. That is, if the images are to be taken in, the respective reduced image of the currently taken image and at least one image of the images taken in past are simultaneously displayed in a predetermined area of the display screen.

If a selection input to select any target one of the images simultaneously displayed in that predetermined area is received through selection-input-receiving device, character information to be displayed on that selected image is recognized by character recognition device. If the character information obtained by character recognition is comprised of information that indicates a communication partner such as a telephone number, ane-mail address, or a URL, communication-related processing is performed by communication-related processing device based on this information.

In such a manner, if the display images are to be taken in, the reduced image of the image currently taken in and that of the image taken in past are displayed, so that it is possible to confirm that the image to be currently taken in has been taken in surely and also that there is an image taken in the past. Further, if the display images are to be taken in serially, it is possible to confirm continuity of the images to be taken in.

Further, if the character information subjected to character recognition indicates a communication partner, this partner is identified on the basis of this information to make a phone call to this identified partner by using the communication-related processing device, create an e-mail and transmit it, or access a Web page. In such a manner, an easy-to-use apparatus for processing an image is realized that is provided with an image take-in function.

By the present invention, it is possible to immediately confirm whether an image is taken in as intended together with an image taken in the past. It is also possible to easily use a plurality of taken images properly depending on purposes. Further, it is possible to recognize characters contained in an image, thereby eliminating a need of a viewer taking notes. Therefore, an easy-to-use apparatus and method for processing an image can be provided for the user.

The concluding portion of this specification particularly points out and directly claims the subject matter of the present invention. However those skill in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is an explanatory diagram of a TV receiver to which first embodiment of an apparatus and a method for processing an image signal according to the present invention is applied;

FIG. 2 is an explanatory illustration of outer appearances of a remote control of the TV receiver of FIG. 1;

FIGS. 3A-3C are explanatory illustrations of a screen memo function in the TV receiver of the first embodiment shown in FIG. 1;

FIG. 4 is an explanatory flowchart of processing during implementation of the screen memo function in the TV receiver of the first embodiment shown in FIG. 1;

FIG. 5 is an explanatory illustration of a capture memory for storing and holding digital data of a captured image as an image file;

FIG. 6 is an explanatory illustration of how to utilize a captured image in the TV receiver of the first embodiment shown in FIG. 1;

FIGS. 7A-7D are explanatory illustrations of a case where character information, which indicates a communication partner, contained in a displayed image as expanded of a captured image is recognized and utilized in the TV receiver of the first embodiment shown in FIG. 1;

FIG. 8 is an explanatory flowchart of processing during implementation of an album function in a control portion 20 of the TV receiver of the first embodiment;

FIG. 9 is an explanatory flowchart of image expansion processing performed at step S15 of the processing shown in FIG. 8;

FIG. 10 is an explanatory flowchart of e-mail processing performed at step S26 shown in FIG. 9;

FIG. 11 is an explanatory flowchart of browser processing performed at step S28 shown in FIG. 9;

FIG. 12 is an explanatory flowchart of other processing performed at step S29 shown in FIG. 9;

FIGS. 13A-13D are explanatory illustrations of a screen memo function in a TV receiver of a second embodiment;

FIGS. 14A and 14B are explanatory flowcharts of processing performed by the control portion 20 upon power application of a TV receiver of the second embodiment;

FIG. 15 is an explanatory flowchart of e-mail processing performed at step S111 shown in FIG. 14B;

FIG. 16 is an explanatory flowchart of browser processing performed at step S113 shown in FIG. 14B; and

FIG. 17 is an explanatory flowchart of sub screen display/non-display processing performed at step S124 shown in FIG. 15 and step S146 shown in FIG. 16.

### DESCRIPTION OF THE PREFERRED EMBODIMENTS

The following will describe one embodiment of an apparatus and a method of the present invention with reference to drawings. The following embodiments are described in an example where an apparatus and a method of the present invention are applied to a TV receiver. It is to be noted that to simplify the description, explanation of an audio signal processing system in the TV receiver of the following embodiments is omitted.

### First Embodiment

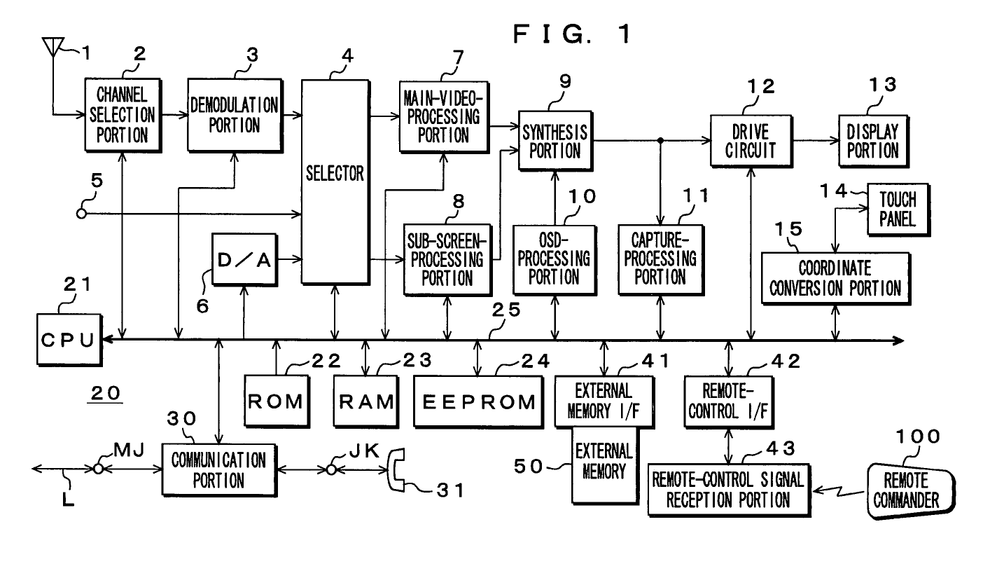

FIG. 1 is an explanatory block diagram of a first embodiment of a TV receiver to which this invention is applied. As shown in FIG. 1, this first embodiment of the TV receiver comprises a channel selection portion (tuner portion) 2 connected to a TV broadcast signal reception antenna 1 installed outdoors, a demodulation portion 3, a selector 4, an external input terminal 5 for a video signal, a digital/analog conversion portion (hereinafter abbreviated as “D/A conversion portion) 6, a main-video-processing portion 7, a sub-screen-processing portion 8, a video synthesis portion (hereinafter referred to as “synthesis portion” simply) 9, an OSD-processing portion 10, a capture-processing portion 11, a drive circuit 12, a display portion 13, a touch panel 14, a coordinates conversion portion 15, and a control portion 20.

The control portion 20 controls these portions of the TV receiver of this first embodiment, and is formed as a micro computer in which a central processing unit (CPU) 21, a read only memory (ROM) 22, a random access memory (RAM) 23, and an electrically erasable programmable ROM (EEPROM) 24 are connected to each other through a CPU bus 25 as shown in FIG. 1.

It is to be noted that the ROM 22 in the control portion 20 records various kinds of processing programs to be executed in the TV receiver of this first embodiment and data necessary in processing. The RAM 23 is mainly used as a working space for various kinds of processing, to temporarily store and hold data obtained in the various kinds of processing, for example. The EEPROM 24, which is a so-called nonvolatile memory so that information once stored and held in it may not be lost even upon power failure, stores and holds various kinds of parameter information.

Further, to the control portion 20, a communication portion 30 is connected. The communication portion 30 is used to connect a communication network such as a telephone network or the Internet and this embodiment of the TV receiver to each other. In the present embodiment, the communication portion 30 is connected to a telephone line L connected to the telephone network.

A terminal MJ connected to the telephone line L is a so-called modular jack used to connect the telephone line L and the TV receiver of the present embodiment to each other. Further, to the communication portion 30, a handset (transmitter/receiver) 31 for communication can be connected through a connection terminal JK.

In this configuration, the TV receiver of this first embodiment can be connected to the Internet through the communication portion 30, the telephone line L, a predetermined Internet service provider (ISP), and the like, to transmit and receive an e-mail and get various kinds of information (contents) of a Web page etc. provided over the Internet.

Further, the TV receiver of this first embodiment can connect a telephone circuit to a target partner via the communication portion 30 and the telephone line L, to communicate with him by using the handset 31. Thus, the communication portion 30 is configured to have a so-called modem function as well to enable a telephone function to be realized.

Therefore, the control portion 20 can control the communication portion 30 so as to be on-hooked/off-hooked and is also provided with a so-called dialer function that a predetermined dial signal may be sent if the communication portion 30 is controlled to off-hook.

Further, to the control portion 20, an external memory interface (hereinafter abbreviated as “external memory I/F”) 41 is connected to enable attaching/detaching an external memory 50 referred to as a memory card that uses a semiconductor memory. If the external memory 50 is attached to the external memory interface 41, this external memory 50 is used as a so-called user memory for storing various kinds of information to be captured, as described later. If the external memory 50 is not attached to the external memory interface 41, on the other hand, the various kinds of information to be captured are recorded in, for example, the RAM 23 or the EEPROM 24.

Further, to the control portion 20, a remote-control signal reception portion 43 is connected through a remote-control I/F 42. The remote-control signal reception portion 43 receives an infrared remote control signal from a remote commander 100, which is a remote-control device, and converts it into an electric signal and supplies it to the control portion 20. Thus, the control portion 20 controls the portions in response to the remote control signal from the remote commander 100 through the remote-control signal reception portion 43 so that processing maybe performed in accordance with a direction input operation performed by the user on the remote commander 100.

The TV receiver of the present embodiment has four basic operation modes: a TV mode in which a TV broadcast signal for channel selection is received to demodulate the channel-selected TV broadcast signal and reproduce it; an Internet mode in which as described above it is connected via the communication portion 30 to the Internet to enable contents such as a Web page provided over the Internet to be accessed; an e-mail mode in which, for example, an e-mail can be created and transmitted/received through the Internet; and a telephone mode in which a telephone circuit is connected through a telephone network to a target partner to enable communication.

In any of the TV mode, the Internet mode, and the e-mail mode, the TV receiver of the present embodiment has a screen memo function to take in (capture) an image (video) displayed on the display screen of the display portion 13 as image data and store and hold it as an image file in a predetermined memory, for example, the external memory 50.

This screen memo function is used to convert an image signal (video signal) that forms one screen of an image (video) displayed on the display screen of the display portion 13 into image data as digital data and take it in, store it in a predetermined memory, and provide a display region referred to as a clipboard in a portion of the display screen of display portion 13 to create a reduced image of the captured image to display the reduced image of the most recently captured image and a reduced image of at least one less recently captured images, for a constant lapse of time.

In this first embodiment, image data that forms a captured image is stored in the external memory 50 if it is attached and, otherwise, in the RAM 23, for example. Further, a clipboard is used to display a maximum of four reduced images of the most recently captured images. Further, in the TV receiver of this first embodiment, the displayed clipboard is automatically erased after it is displayed for about two seconds.

In this first embodiment, as described later, individual images captured through the screen memo function are each utilized by using an album function. The album function has an object to manage together captured images and images obtained with a digital camera and utilize each of the images, thus enabling a list of reduced images of these management-subject images to be displayed, a selection input to be accepted, a reduced image thus selected to be expanded and displayed (i.e. to original size on the overall display screen), etc. It is noted that the above list includes a thumbnail images or documents, thumbnail screenshots and the like.

Furthermore, the TV receiver of this first embodiment is provided with a character recognition function to perform character recognition processing on character information such as a telephone number, an e-mail address, or a URL if it is contained in an image displayed as expanded by the album function so as to be utilized, so that the recognized character information can be used to automatically make a phone call, create an e-mail and transmit it to a target communication partner, or access a target Web page to be provided with information.

That is, if a captured image contains information which identifies (specifies) a communication partner such as a telephone number, an e-mail address, or a URL, such information need not be input by the user but just is subjected to character recognition so that it may be acquired as utilizable data and utilized secondarily. Specifically, as described later also, if the user instructs use of information that is obtained with the character recognition function and identifies a communication partner, it is possible to control the communication portion 30 based on the information that identifies a communication partner detected by character recognition, thereby communicating with the target partner.

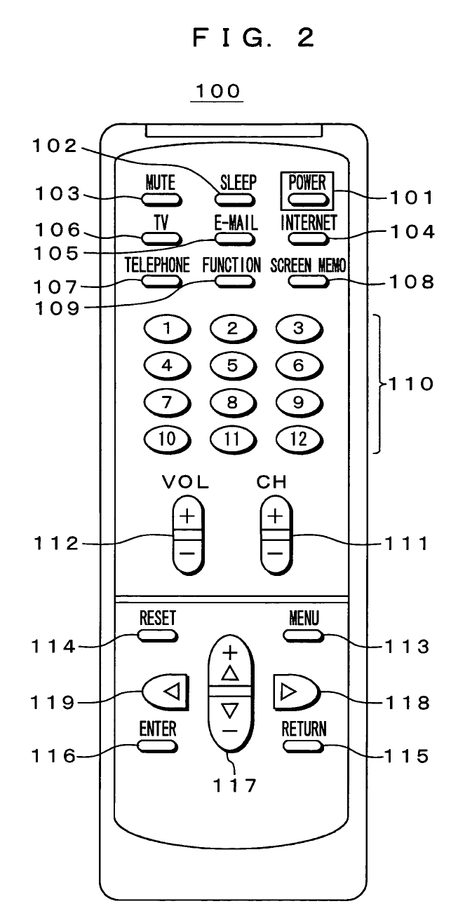

Further, in the TV receiver of the present embodiment, operation keys on the remote commander 100 can be used to manually switch the modes and implement the functions. FIG. 2 is an explanatory illustration of one example of the remote commander 100 of the TV receiver of the present embodiment.

As shown in FIG. 2, the remote commander 100 used in the TV receiver of the present embodiment is equipped with a power ON/OFF key 101 as well as various function keys such as a sleep function ON/OFF key 102, a mute function ON/OFF key 103, an Internet-mode switch-on key 104, an e-mail mode switch-on key 105, a TV-mode switch-on key 106, a telephone-mode switch-on key 107, a screen-memo function implementation key 108, and an miscellaneous function key 109.

Further, the remote commander 100, as shown in FIG. 2, is equipped with a channel-selection numeric key group 110, a TV-broadcast signal channel-selection UP/DOWN key 111, a sound-volume UP/DOWN key 112 and, to enable performing of processing selected from a prepared menu, a menu-display ON/OFF key 113, a reset key 114, a return key 115, an enter key 116, an UP/DOWN key 117 used to move a cursor, a right arrow key 118, and a left arrow key 119.

The remote commander 100 generates a remote control signal in accordance with the operation key operated by the user and sends it as an infrared signal. In such a manner, the user can use the remote commander 100 to turn ON/OFF a power source and also the sleep function or the mute function as described above. Further, in the TV mode, the e-mail mode, or the Internet mode, the screen memo function can be implemented by pressing the screen-memo function implementation key 108.

Further, by pressing the Internet-mode switch-on key 104, the e-mail mode switch-on key 105, the TV-mode switch-on key 106, and the telephone-mode switch-on key 107, the corresponding modes can be switched on.

In the TV receiver of this first embodiment, immediately after power application, the TV mode is entered under the control of the control portion 20. In this TV mode, a TV broadcast signal received through the antenna 1 is supplied to the channel selection portion 2.

The channel selection portion 2 selects such a TV broadcast signal of these TV broadcast signals from the reception antenna 1 as to be in accordance with a channel-selection direction signal from the control portion 20 and supplies this selected TV broadcast signal to the demodulation portion 3. The demodulation portion 3 demodulates this supplied TV broadcast signal and supplies a demodulated video signal (image signal) to the selector 4.

The selector 4 is supplied with, as well as the video signal from the demodulation portion 3, a video signal (image signal) received through the external input terminal 5 for video signals and a video signal (image signal) sent from the control portion 20 through the D/A conversion portion 6. The external input terminal 5 is used to receive an analog video signal supplied from an external device such as a VCR or a DVD device, for example. Further, a video signal supplied from the control portion 20 to the selector 4 through the D/A conversion portion 6 constitutes so-called Web page information provided over, for example, the Internet taken in through communication portion 30, information such as an e-mail destined to itself, or various kinds of display information formed by the control portion 20 such as an e-mail creation screen.

The selector 4 selects by switching, in accordance with a switching control signal from the control portion 20, which one of a video signal from the demodulation portion 3, a video signal from the external input terminal 5, and a video signal supplied from the control portion 20 through the D/A conversion portion 6 is to be supplied to the main-video-processing portion 7 or to the sub screen processing portion 8.

The main-video-processing portion 7 forms display signals (component signals R-Y, B-Y, and Y) from the video signal (TV signal) from the selector 4 and supplies them to the synthesis portion 9. The sub screen-processing portion 8, on the other hand, forms display signals (component signals) from the video signal from the selector 4 in such a manner as to match a size of a display region as the sub screen provided in one region of the display screen of the display portion 13 and also performs processing to reduce an image corresponding to the display signals to form a display signal to display a video on the sub screen and then supplies it to the synthesis portion 9.

The synthesis portion 9 synthesizes the display signal from the main-video-processing portion 7 and the display signal from the sub-screen-processing portion 8, to enable to be displayed a video in a two-screen display mode, which is referred to as a so-called “picture-in-picture (PinP) mode”, in the TV receiver of the present embodiment.

In the PinP mode, a sub screen is provided in a portion of the display screen of the display portion 13 to use regions other than this sub screen as a parent screen so that videos may be displayed on the child and parent screens independently of each other. In this first embodiment, a video corresponding to the display signal from the main-video-processing portion 7 is displayed on the parent screen and that corresponding to the display signal from the sub-screen-processing portion 8 is displayed on the sub screen.

Further, to the synthesis portion 9, a display signal from the OSD-processing portion 10 is also supplied as shown in FIG. 1. The OSD-processing portion 10 forms, in accordance with data supplied from the control portion 20, a display signal of an image to be multiplexed to an image which is displayed on the display screen of the display portion 13. This OSD-processing portion 10 forms a display signal of a variety of images to be multiplexed such as an operation guidance or a reduced image of a captured image which is displayed on a clipboard.

The synthesis portion 9 synthesizes a display signal (video signal for display on the parent screen) from the main-video-processing portion 7, a display signal (video signal for display on the sub screen) from the sub-screen-processing portion 8, and a display signal (video signal for forming an image to be multiplexed) of an image to be multiplexed that is sent from the OSD-processing portion 10, to form a signal for displaying a video on the display screen of the display portion 13 and supply it to the drive circuit 12 and the capture-processing portion 11.

The drive circuit 12 amplifies a color signal or a luminance signal, which is a display signal supplied to it, to a level necessary to drive the display portion 13 or takes out a vertical or horizontal synchronization signal and supplies it to the display portion 13. In such a manner, an image in accordance with the display signal from the synthesis portion 9 is displayed on the display screen of the display portion 13.

Thus, different videos (images) corresponding to different video signals can be displayed on the parent screen and the sub screen, so that if, for example, it is necessary to create an e-mail and transmit it during viewing of a TV broadcast program, the e-mail mode is switched on to display the e-mail creation screen on the parent screen, thereby enabling creation of the e-mail and a display, on the sub screen, of an image of the TV broadcast program corresponding to a received TV broadcast signal to view it.

In this case, the control portion 20 controls the selector 4 so that a video signal from the demodulation portion 3 can be supplied to the sub-screen-processing portion 8 and a video signal for forming the e-mail creation screen supplied through the D/A conversion portion 6 from the control portion 20 can be supplied to the main-video-processing portion 7, to enable creation of the e-mail on the e-mail creation screen displayed on the parent screen while continuously viewing the TV broadcast program on the sub screen. Similarly, it is also possible to display a video of a Web page on the parent screen and a video of a TV broadcast program on the sub screen.

In such a manner, when two-screen display is directed, it is possible to display videos corresponding to different video signals on display areas of the parent screen and the sub screen, respectively, and also multiplex a captured image on a clipboard or display information such as operation guidance on these images and display it.

If two-screen display is not directed, on the other hand, a video corresponding to a display signal from the main-video-processing portion 7 is displayed on the overall display screen of the display portion 13. Further, multiplexed images from the OSD-processing portion 10 are not always displayed; rather, necessary information is displayed as necessary under the control of the control portion 20.

Further, the capture-processing portion 11 is equipped with a frame memory, to always take in as digital data a display signal (video signal) for forming an image, which is displayed on the display screen of the display portion 13. Therefore, when the screen memo key 108 on the remote commander 100 shown in FIG. 2 is pressed and operated, an image currently displayed on the display screen of the display portion 13 is taken in as image data by a function of the capture-processing portion 11.

As described above also, the image data of this image thus taken is recorded, under the control of the control portion 20, in the external memory 50 if it is attached or in the RAM 23 if it is not attached, as an image file so that the image can be managed and utilized by using the album function as described later also.

Thus, the TV receiver of this first embodiment is not only used for viewing a TV broadcast program but also is provided with Internet utilization functions such as creation and transmission of ane-mail, reception of an e-mail destined for itself, and accessing of a Web page as well as with a telephone function. It is provided also with the screen memo function to capture a video displayed on the display screen of display portion 13 as well as the album function to manage and utilize image data for forming a captured image.

[Utilization of Screen Memo Function]

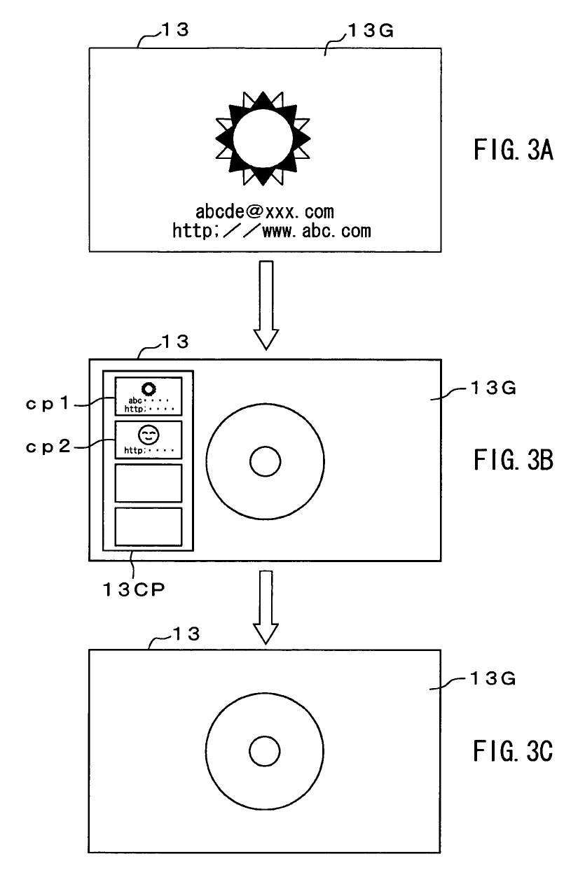

As described earlier also, the TV receiver of the present embodiment has the screen memo function to enable an image displayed on the display screen of the display portion 13 to be taken in as image data and utilized. FIGS. 3A-3C are explanatory illustrations of the screen memo function in the TV receiver of the present embodiment.

As described above also, the TV receiver of the present embodiment can display a TV broadcast program image, an externally input image, a Web page image, an e-mail image, etc. on the display screen of the display portion 13 and take in (capture) one screen of those displayed images (videos) as image data.

For example, in a case where a TV broadcast program image containing an e-mail address or a URL is displayed on a display screen 13G of the display portion 13 as shown in FIG. 3A, if the user presses the screen memo key 108 on the remote commander 100, the corresponding remote control signal is sent from the remote commander 100 and received by the remote-control signal reception portion 43 of the TV receiver of the present embodiment.

In this case, the control portion 20 of the TV receiver controls the capture-processing portion 11 so that a video signal for forming a video displayed on the display screen 13G of the display portion 13 may be taken in as image data and recorded as an image file in the external memory 50 mounted to itself. In this case, the control portion 20 controls an audio-signal-processing portion of the audio signal system, not shown, so that an alarm sound indicating that a displayed image is captured can be produced by a speaker equipped to the TV receiver of the present embodiment.

Furthermore, the control portion 20 supplies the OSD-processing portion 10 with image data that forms a reduced image of the most recently captured image and image data that forms reduced images of the most recent three images of those captured previously, to display a clipboard 13CP on which the reduced images of the captured images are displayed, on the left side in the display screen 13G, as shown in FIG. 3B.

In the case of FIG. 3B, two captured images of reduced image cp1 of the most recently captured video and reduced image cp2 of the previously captured image are displayed on the clipboard 13CP. That is, an example of FIG. 3B shows a case where two images are captured by the screen memo function.

The clipboard 13CP on which the reduced images of the captured images are thus displayed is displayed for a constant lapse of time (e.g., two seconds) and erased from the display screen 13G automatically; then, as shown in FIG. 3C, only an original image, here a video of the TV broadcast program, is displayed.

It is to be noted that if the screen memo key 108 is pressed and operated twice or more consecutively, images displayed on the display screen 13G of the display portion 13 can be captured consecutively, to store and hold their respective items of image data as image files in the external memory 50 etc.

In this case also, each time the screen memo key 108 is pressed, a capture implementation sound is produced from the speaker of the TV receiver and the clipboard 13CP on which a reduced image of the most recently captured image is located at its upper side is displayed and automatically disappears after a predetermined lapse of time elapses.

In such a manner, each time the screen memo key 108 is pressed and operated, an image signal that forms an image displayed on the display screen 13G is taken in as image data (digital data) and stored and held as an image file, in which case, each time the screen memo key is pressed to capture a displayed image, the user can securely confirm that a target image has been captured by production of the capture implementation sound and display of the clipboard 13CP, that is, sound and display.

Moreover, the clipboard 13CP is capable of displaying reduced videos of a plurality of captured videos and so can notify the user of existence of images captured in the past and also, if images are captured serially, makes it possible to confirm whether target videos have been serially captured properly.

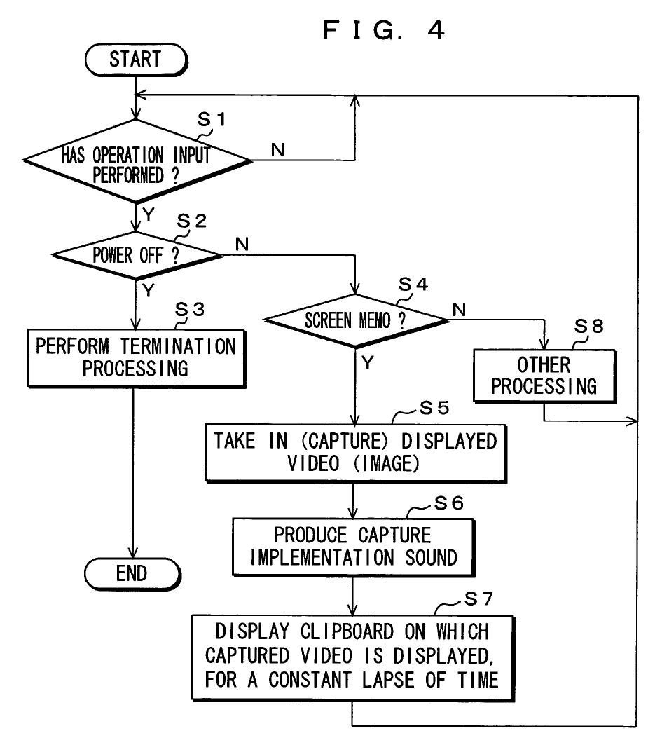

The following will describe operations of the TV receiver of the present embodiment mainly when the screen memo function is implemented, with reference to the flowchart in FIG. 4. FIG. 4 shows processing performed by the control portion 20 when power is applied to the TV receiver of the present embodiment.

When power is applied, the control portion 20 of the TV receiver of the present embodiment waits for an operation input from the user (step S1). The control portion 20 decides whether an operation input from the user through the remote-control signal reception portion 43 or the touch panel 14 has been received. If it is decided not to receive it at decision processing at step S1, the process repeats processing starting from step S1 and, otherwise, decides whether the received operation input directs to turn off power (step S2).

If it is decided at step S2 that the received operation input directs to turn off the power, the control portion 20 performs end processing, for example, to stop supply of power to the portions (step S3) to end the processing shown in FIG. 4. If it is decided at step S2 that the received operation input does not direct to turn off the power, the control portion 20 decides whether the received operation input directs to implement the screen memo function (step S4).

If it is decided at step S4 that the received operation input directs to implement the screen memo function, the control portion 20 controls the capture-processing portion 11 so that a video signal that forms a displayed video may be recorded as digital data in a predetermined memory, here the external memory 50 attached to the TV receiver (step S5).

In this case, the control portion 20 controls a sound-signal-processing portion, not shown, in the TV receiver to produce an alarm sound notifying the user of capture of the video through the speaker (step S6) and supplies the OSD-processing portion 10 with data for displaying reduced images of a plurality of captured images to be displayed on the clipboard 13CP so that the clipboard 13CP may be displayed for a constant lapse of time on which the reduced images of the plurality of captured images is to be displayed (step S7) as shown in FIG. 3B. In processing of step S7, after the clipboard 13CP is displayed for the lapse of time, the control portion 20 repeats the processing starting from step S1 to enter a state for waiting for a user's operation input.

If it is decided at step S4 that the received operation input does not direct to implement the screen memo function, on the other hand, the control portion 20 permits performing of any other processing in accordance with the received remote control signal, for example, selection of a broadcast channel, adjustment of a sound volume or a picture quality, switch-over of the mode, etc. (step S8). After the processing of this step S8, the control portion 20 repeats the processing starting from step S1, to enter the state for waiting a user's operation input.

In such a manner, in the TV receiver of this first embodiment, only by a simple operation of pressing the screen memo key 108, an image displayed on the display screen 13G of the display portion 13 is taken in as image data and stored in the predetermined memory and also a reduced image of the most recently taken image and reduced images of a plurality of images captured earlier are pasted to the clipboard 13CP to be displayed for a constant lapse of time. Further, a sound can also be used to notify the user of capture of a video, thereby preventing occurrence of a trouble such as a case where it cannot be known whether a target video has been captured properly.

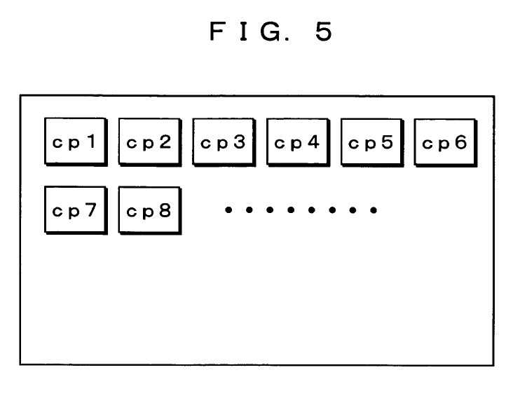

Further, as described above, in the case of the TV receiver of this first embodiment, image data of a plurality of captured images can be stored and held so that the plurality of captured images may be managed together and each utilized individually. FIG. 5 is an explanatory illustration of a capture memory for storing and holding digital data of a captured video as an image file.

In the TV receiver of the present embodiment, the external memory 50 is used as the capture memory. In FIG. 5, as indicated by cp1, cp2, cp3, . . . , the capture memory records in it items of image data of captured individual images as image files so that they may be managed and individually utilized as described above.

It is to be noted that the capture memory can record in it the image data of a plurality of images depending on its memory capacity. If image data of captured images is recorded in the capture memory to its full capacity, the user is notified of, for example, insufficiency of the memory capacity and prompted to clean up (erase) unnecessary captured images or erase all of the captured images.

[Utilization of Images Captured by Screen Memo Function]

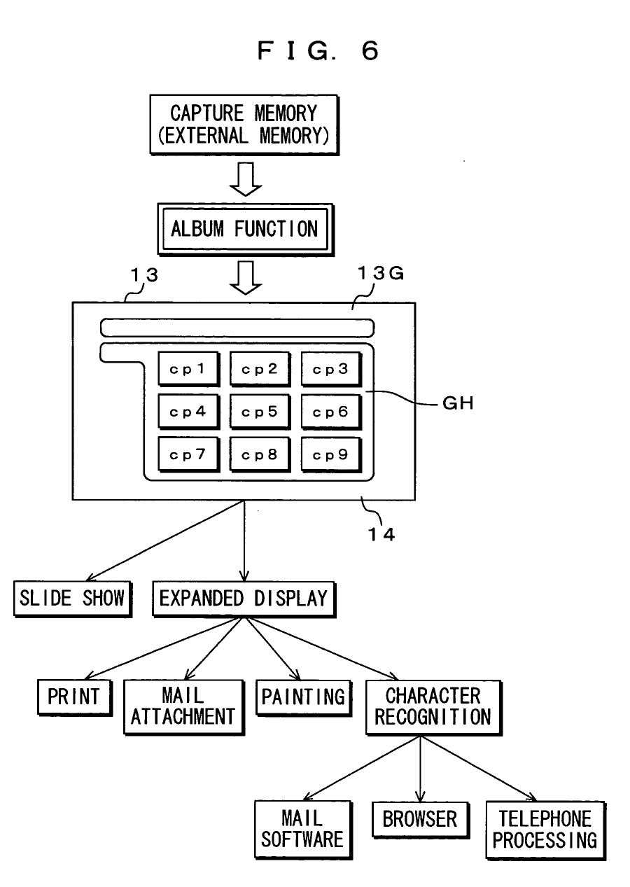

The following will describe how to utilize an image captured by the screen memo function. FIG. 6 is an explanatory illustration of how to utilize a captured image in the TV receiver of the present embodiment. As described with reference to FIG. 5, the capture memory records in it the items of image data of a plurality of captured images as image files cp1, cp2, cp3, . . . , respectively.

By using the album function, these individual image files can be displayed in list display GH of reduced images of the captured images as shown in the display screen 13G of the display portion 13 in FIG. 6. Here, as shown in FIG. 6, nine reduced images are displayed on one screen, so that by scrolling display, the reduced images of all the images can be displayed which are stored and held in the capture memory.

This list display GH is given when the control portion 20 reads items of image data of a plurality of images which is displayed on one screen from the capture memory and performs reduction processing on it so that it may be listed, to form digital data necessary to give the list display GH and supply this through the D/A conversion portion 6 and the selector 4 to the main-video-processing portion 7.

Then, as indicated by a down arrow at the lower side of the display portion 13 in FIG. 6, in the TV receiver of the present embodiment, slide-show display and expanded display (which is processing to display a selected reduced image on the overall display screen 13G) as roughly divided can be performed by using the album function.

To expand the display further, an image to be expanded and displayed is printed, attached to e-mail, or utilized in painting so that character information contained in this image such as an e-mail address, a URL, or telephone can be recognized.

In a case where the character information contained in the image to be expanded and displayed is to be subject to character recognition, as described later also, e-mail software (e-mail program), a browser, or telephone processing software is automatically activated to perform communication processing automatically as shown at the bottom of FIG. 6.

It is to be noted that the e-mail software, which is generally referred to as mail software or a mailer, is used to create e-mail, transmit the created e-mail, or receive and view e-mail destined for itself. Further, the browser is software (viewing software) used to view a Web page over the Internet. Further, the telephone processing software is used to control the communication portion 30 and connect a telephone circuit between itself and a target communication partner, thereby realizing telephone functions for communication.

Slide-show display is used to receive an input for selecting a plurality of target images from list display GH and display each of these selected images on the overall display screen 13G of the display portion 13 for a constant lapse of time. Of course, it is also possible to display images corresponding to an image file recorded in the capture memory in a predetermined order, for example, an order in which they were recorded, for the constant lapse of time. Further, it is also possible to display an image selected by the user or all the recorded images at timing in accordance with a user's direction.

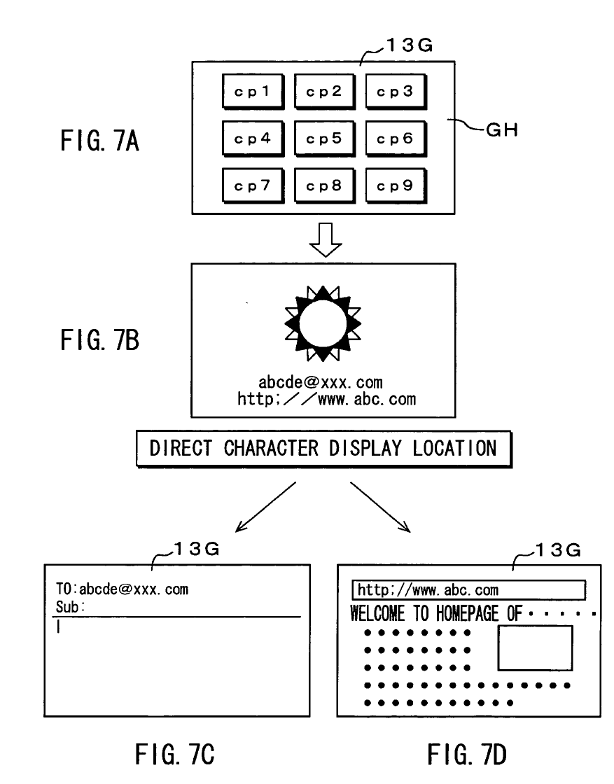

FIGS. 7A-7D are explanatory illustrations of an example where character information, which indicates a communication partner, contained in a displayed image as expanded of a captured image is recognized and utilized. If, as shown in FIG. 7A, the album function is implemented to provide list display GH of reduced images of captured images and, when an image intended to be expanded and displayed is selected, the selected reduced image is displayed as expanded on the display screen 13G of the display portion 13 of the TV receiver as shown in FIG. 7B. An example of FIG. 7B shows a case where a reduced image containing an e-mail address and a URL is displayed as expanded.

It is to be noted that selection of a reduced image intended to be expanded and displayed can be such that, for example, when the user touches by his finger a position on the display screen 13G to which the touch panel 14 on which the target image is displayed is attached and the control portion 20 recognizes the touched position through the touch panel 14 and the coordinate conversion portion 15 and determines a reduced image displayed at the touched position as a selected image.

Further, when the arrow keys 117, 118, 119, etc. on the remote commander 100 are operated to move a cursor capable of being placed to one of displayed reduced images so that the cursor may be located to a target reduced image and the enter key 116 is pressed, the control portion 20 can recognize the reduced image where the cursor is located, as a selected image.

To recognize a character string indicated in an image displayed as expanded, a position of the character string to be recognized is pointed. Specifically, a location of the target character string displayed on the display screen 13G is touched by the finger etc. and thus recognized by the control portion 20 through the touch panel 14 and the coordinate conversion portion 15, so that this recognized touched location can be used as a reference to recognize a character string displayed within a predetermined range on the display screen 13G.

For example, in FIG. 7B, when a character string of e-mail address “abcde@xxx.com” is touched by the finger etc. on the display screen 13G, the touched location is recognized by the control portion 20 through the touch panel 14 and the coordinate conversion portion 15, so that the recognized touched location can be used as a reference position to perform character recognition laterally of the display screen, thereby recognizing the displayed character string “abcde@xxx.com”.

If a character, “@” is contained in the recognized character string, the control portion 20 recognizes this as an e-mail address. In this case, as described later also, the control portion 20 activates e-mail software to automatically set the recognized e-mail address as a sending destination of e-mail so that the e-mail can be created and transmitted as shown in FIG. 7C.

In FIG. 7B, when character string, “http;//www.abc.com” is touched by the finger etc. on the display screen 13G, the touched location is recognized by the control portion 20 through the touch panel 14 and the coordinate conversion portion 15, so that the recognized touched location can be used as a reference position to perform character recognition laterally of the display screen, thereby recognizing the displayed character string, “http;//www.abc.com”.

If character string, “http” is contained in the recognized character string, the control portion 20 recognizes this as a URL. In this case, as described later also, the control portion 20 activates a browser to connect to the Internet through a predetermined ISP so that a target Web page can be automatically accessed by using the recognized character string URL as shown in FIG. 7D.

It is to be noted that if the recognized character string is comprised of only numbers or numbers and hyphens, it can be decided to be a telephone number. If the recognized character string is decided to be a telephone number, the control portion 20 executes telephone-processing software to enable phone call to be made to a partner with that telephone number for communication.

Although it has been described that to perform character recognition, a location of a target character string is input through the touch panel 14 and the coordinate conversion portion 15, the present invention is not limited to it. For example, a pointer displayed on the display screen 13G can be moved through the remote commander 100, to point a display range for a character string to be recognized.

[Album Function]

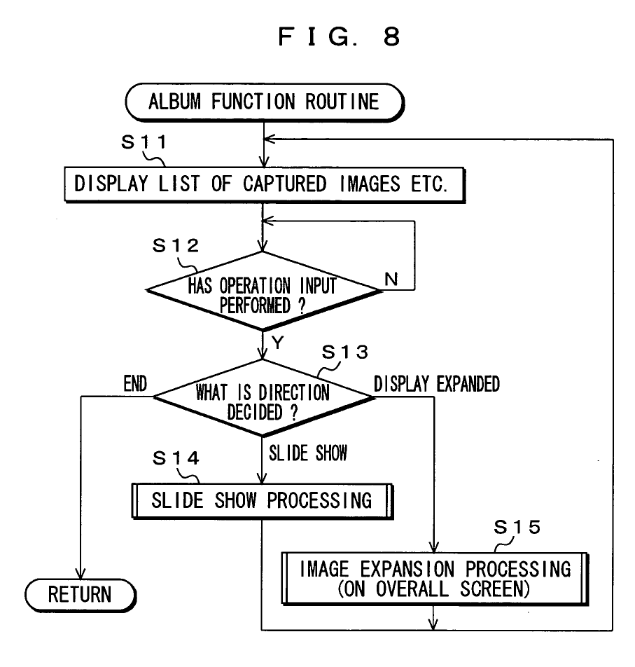

The following will describe the album function and image expansion processing that are used to utilize an image captured by the screen memo function. FIG. 8 is an explanatory flowchart of processing during implementation of the album function in the control portion 20 of the TV receiver of the present embodiment.

In the TV receiver of the present embodiment, by selecting the album function from a menu displayed on the display screen 13G of the display portion 13, an album function routine shown in FIG. 8 is executed. When the album function routine is executed, the control portion 20 in the TV receiver of the present embodiment reads image data of a captured image stored in a predetermined capture memory, the external memory 50 in the present embodiment, to list reduced images of the respective captured images (step S11).

Although it has been described that the reduced images to be listed had been captured, the present invention is not limited to it. As described above, images taken in by a digital camera are also included. If they cannot be displayed on one screen, by scrolling the screen, recorded images can all be displayed serially, to find a target image.

Then, the control portion 20 waits for an operation input from the user to be received through the remote commander 100 or the touch panel 14 (step S12). As described above also, the TV receiver of the present embodiment can receive an operation input from the user through display of an icon or selection items and the touch panel 14 displayed on the display screen 13G of the display portion 13 or through the remote commander 100.

As a specific example of the operation input, for example, to terminate the album function to be implemented, the touch panel 14 on the display screen 13G of the display portion 13 on which a termination icon is displayed can be touched by the finger etc., to direct ending the album function. Further, to provide slide-show display, similarly, the touch panel 14 on the display screen 13G of the display portion 13 on which a slide-show icon is displayed can be touched by the finger etc., to direct implementing slide-show display.

Further, to expand and display a captured image, as described above also, the touch panel 14 on the display screen 13G of the display portion 13 on which such a reduced image of those listed as to be expanded and displayed is displayed can be touched by the finger etc., to select the reduced image to be expanded and displayed and also, the touch panel 14 on the display screen 13G of the display portion 13 on which an expanded display icon is displayed can be touched by the finger etc., to direct expansion and display of the selected reduced image.

If it is decided at step S12 that the above-described operation input is received from the user, the process judges directed contents indicated by that received operation input (step S13). If it is decided at step S13 that termination of the album function is directed, the control portion 20 ends the album function routine shown in FIG. 8.

If it is decided at step S13 that slide-show display is directed, as described above also, the process receives an input for selecting a captured image to be used in a slide show and performs slide-show processing to, for example, automatically show each of the selected images for constant lapse of time (step S14) and, when the slide-show processing ends, the control portion 20 in the TV receiver of the present embodiment repeats the processing starting from step S11.

If it is decided at step S13 that expansion and display of an image is directed, as described with reference to FIG. 7, the image is expanded and displayed (processing to display the image on the overall screen by using image data of a reduced image), to perform expansion processing for character recognition, printing, mail attachment, painting, etc. (step S15) and, when the image expansion processing ends, the control portion 20 in the TV receiver of the present embodiment repeats the processing starting from step S11.

In such a manner, it is possible to list TV broadcast program images taken by capturing, images sent from an external device, images taken through the Internet, and even images acquired by a digital camera and provide slide-show display or expanded display of them, thus utilizing them in various forms.

[Image Expansion Processing]

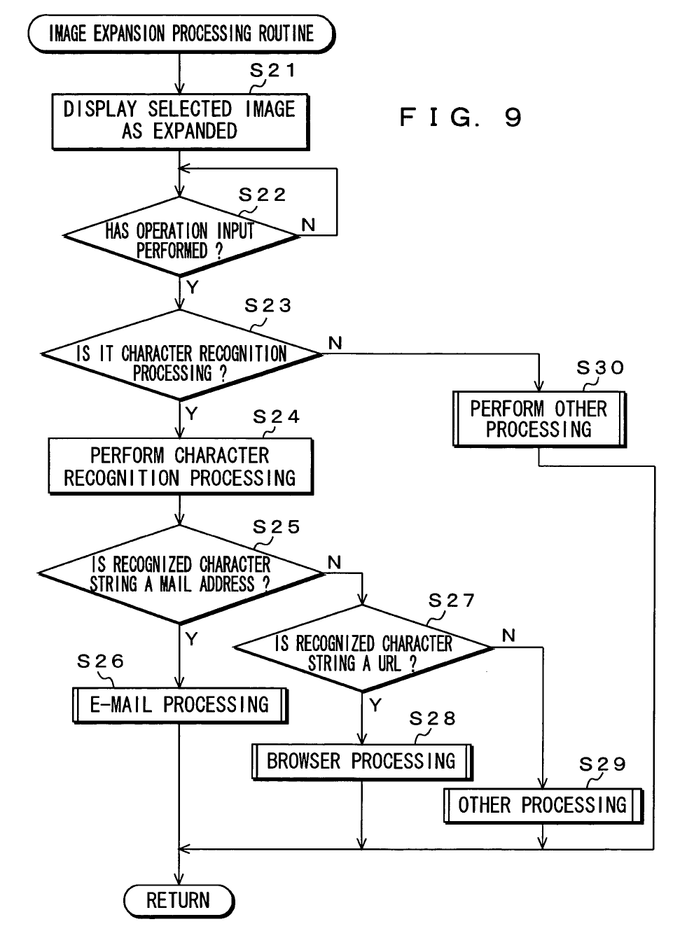

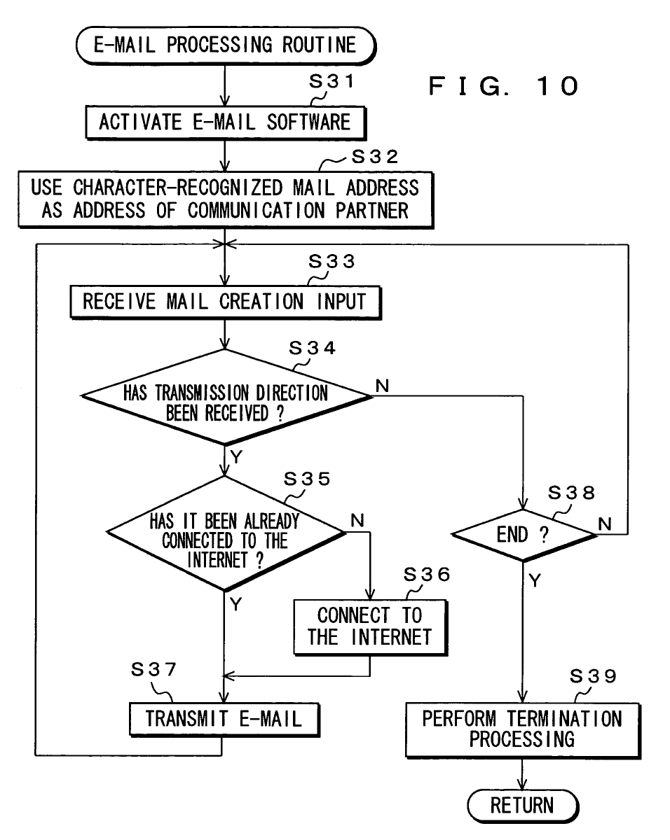

The following will describe image expansion processing performed at step S15 of the album function routine shown in FIG. 8. FIG. 9 is an explanatory flowchart of the image expansion processing performed at step S15 of the processing shown in FIG. 8.

If it is directed to expand an image, the control portion 20 in the TV receiver of the present embodiment first displays an image selected from a list as an image video to be displayed as expanded on the display screen 13G of the display portion 13 to the fullest (expanded display) (step S21) as described above also and waits for an operation input from the user (step S22). If it is decided at step S22 that an operation input is received from the user, the process decides whether the operation input directs to perform character recognition processing (step S23).

In this case, the operation input that directs performing of the character recognition processing is decided to be a direction for performing of the character recognition if, for example, the touch panel 14 on the display screen on which character information to be recognized is displayed is touched by the user's finger or if as-touched movement, that is, dragging is detected.

The control portion 20 performs character recognition processing on a character string displayed within a predetermined range on the display screen 13G on which a location touched by the finger etc. is used as a reference or a character string displayed on the display screen 13G that corresponds to a dragged section (range from a position touched first to a position touched last).

If it is directed to perform processing other than character recognition, the process can decide whether it is directed to print something, paint something, or attach something to e-mail in accordance with an icon displayed at a location on the display screen 13G that corresponds to a location on the touch panel 14 touched by the user's finger etc.

If it is decided at step S23 that the received operation input directs performing of the character recognition processing, the control portion 20 defines an area in which an image to be subject to character recognition is displayed, with respect to a location indicated by the user of an image displayed on the display screen 13G of the display portion 13 and forms matching data required to perform pattern matching from image data of the image displayed on that display area and also performs pattern matching between this formed matching data and matching data of a character prepared in the ROM 22 in the control portion 20 beforehand to recognize the character and encode the recognized character into character data and store and hold it in, for example, the EEPROM 24 (step S24).

In such a manner, the control portion 20 in the TV receiver of this first embodiment recognizes as character information a character string displayed in an image taken into the capture memory such as the external memory 50, by using a so-called pattern matching method, and sores and holds it in the EEPROM 24 so that it can be utilized secondarily.

Then, the control portion 20 decides whether the recognized character string is an e-mail address (step S25). If it is decided at step S25 that the recognized character string is an e-mail address containing the character, “@”, the control portion 20 performs e-mail processing described later also (step S26) and ends the processing shown in FIG. 9.

If it is decided otherwise at step S25, the process decides whether the recognized character string is a URL containing the character string, “http” (step S27). If such is the case, it performs browser processing described later also (step S28) and ends the processing shown in FIG. 9.

If it is decided at step S27 that the recognized character string is not a URL, on the other hand, it performs other processing, that is, telephone processing or message display processing as described later also (step S20) and ends the processing shown in FIG. 9.

If it is decided at step S23 that the received operation input does not direct performing of character recognition processing, the control portion 20 performs processing that utilizes a selected image in accordance with a user's direction such as printing of the selected image, its utilization in painting, or its attachment to e-mail (step S30) and ends the processing shown in FIG. 9.

[Post-Character Recognition Processing]

The following will describe e-mail processing performed at step S26, browser processing performed at step S28, other processing performed at step S29 in a case where a character is recognized in image expansion processing shown in FIG. 9.

[E-mail Processing]

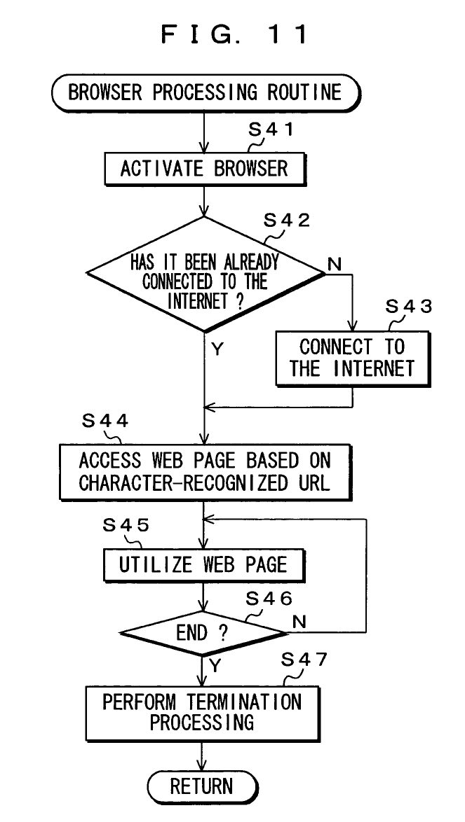

FIG. 10 is an explanatory flowchart of e-mail processing performed at step S26 shown in FIG. 9. That is, if a recognized character string is decided to be an e-mail address, the control portion 20 performs processing shown in FIG. 10, to first activate e-mail software (step S31) to display the e-mail creation screen and, on it, automatically set the e-mail address thus obtained by character recognition to be used as a destination address (step S32) and receive an e-mail creation input (step S33).

The control portion further decides whether it is directed to transmit the created e-mail (step S34) and, if such is the case, decides whether connection to the Internet is established (step S35). If it is decided at step S35 that connection to the Internet is not established, the control portion 20, for example, performs processing to connect to the Internet through a predetermined ISP (step S36).

If it is decided at step S35 that connection to the Internet has already been established or if processing at step S36 is performed to establish connection to the Internet, the control portion 20 transmits the created e-mail to a destination server with mail-box functions that is specified by the recognized e-mail address (step S37). Then, it returns to the processing starting from step S33, to continue creation of e-mail.

If it is decided at step S34 that transmission is not directed, the process decides whether it is directed to end the processing (step S38). If it is decided at step S33 that it is not directed to end the processing, the control portion 20 repeats the processing starting from step S33. Otherwise, the control portion 20 performs termination processing to end the e-mail software etc. (step S39), to end the processing shown in FIG. 10.

It is thus possible to create e-mail by automatically using a recognized e-mail address as an address to which the e-mail is to be transmitted, thus transmitting the created e-mail. Therefore, the user can activate e-mail software to create e-mail and transmit it to a target partner without manually inputting an e-mail address of the target partner.

[Browser Processing]

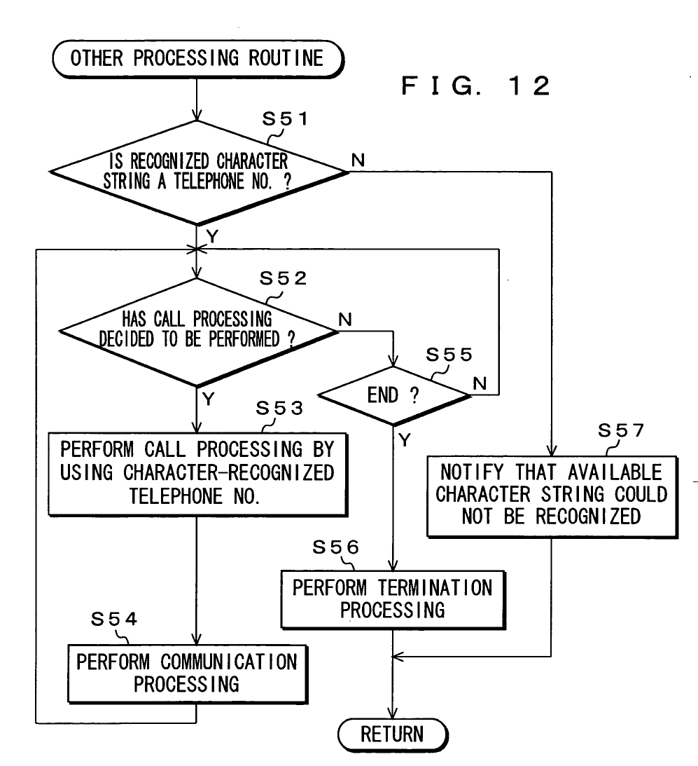

FIG. 11 is an explanatory flowchart of browser processing performed at step S28 shown in FIG. 9. That is, if a recognized character string is decided to be a URL, the control portion 20 activates a browser (step S41) and decides whether connection to the Internet is established (step S42). If it is decided at step S42 that connection to the Internet is not established, the control portion 20 performs processing to connect to the Internet through, for example, a predetermined ISP.

If it is decided at step S42 that connection to the Internet has already been established or if processing at step S43 is performed to establish connection to the Internet, it automatically accesses a Web page identified by a URL acquired through character recognition (step S44) and displays the Web page so that it can be utilized (step S45). The target Web page can be utilized variously, for example, to scroll it to obtain necessary information or print its contents.

The process decides whether termination is directed (step S46) and, if it is decided not so, repeats the processing starting from step S45. If it is decided at step S46 that termination is directed, the control portion 20 performs termination processing to terminate the browser (step S47), to end the processing shown in FIG. 11.

It is thus possible to access a target Web page by using a recognized URL. Therefore, the user can activate a browser to automatically access a target Web page without manually inputting a URL of the target Web page.

[Other Post-Character Recognition Processing]

FIG. 12 is an explanatory flowchart of other processing performed at step S29 shown in FIG. 9. That is, if a recognized character string is decided not to be an e-mail address nor to be a URL, the control portion 20 decides whether the recognized character string is a telephone number (step S51). If it is decided at step S51 that the recognized character string is a telephone number, it decides whether it is directed to perform call processing (step S52).

If it is decided at step S52 that it is directed to perform call processing, that is, if it is decided that a predetermined operation to direct performing of call processing is received, the control portion 20 performs call processing by using a telephone number acquired by character recognition as a telephone number of a call partner (callee), to connect a telephone circuit (step S53).

It waits for response from the partner and, if the telephone circuit is connected, communicates with him and, after it is finished, performs on-hook processing in response to the user's direction and, if the line is busy or communication is disabled due to no response from the partner, perform on-hook processing, that is, call processing in response to the user's direction (step S54). After that, it repeats the processing starting from step S52.

If it is decided at step S52 that it is not directed to perform call processing, it decides whether it is directed to end the processing (step S55). If it is decided at step S55 that it is not directed to end the processing, it repeats the processing starting from step S52. If it is decided at step S55 that it is directed to end the processing, it performs predetermined termination processing (step S56), to end the processing shown in FIG. 12.

If it is decided at step S51 that the recognized character string is not a telephone number, it means that the recognized character string is, after all, not an e-mail address nor a URL nor a telephone number, so that the process notifies that it could not recognize information that indicates a communication partner who can be utilized in communication processing (step s57) and performs termination processing (step S56), to end the processing shown in FIG. 12.

It is thus possible to automatically call a target partner by using a character-recognized telephone number. Therefore, the user can call a target partner for communication without manually inputting any telephone number.

### Summary of the First Embodiment

In the above-described first embodiment, by using the screen memo function, it is possible to take in (capture) an image displayed on the display screen 13G of the display portion 13 as image data and save it in a memory as an image file. In this case, images can also be captured serially and, if they are done so, it is possible to display reduced images of thus captured images on a clipboard, to clearly notify the user that the target images have been captured.

If an image is captured, a sound (capture sound) that notifies of the capture can be produced to enable the user to recognize the image being captured through his sense of hearing too.

Further, the clipboard is capable of displaying on it the most recently captured image as well as an image captured in the past, if any, so that for example, serially captured images, if any, can be recognized and, each time an image is captured in the past, it can be posted to the user.

These captured images can be displayed in slide-show display or as expanded by using the album function so that they can be printed, used in painting, or attached to e-mail. Further, if an e-mail address, a URL, a telephone number, etc. is displayed on an image displayed as expanded, such information is obtained through character recognition so that the user can automatically communicate with his partner without inputting any communication partner identification information such as an e-mail address, a URL, or a telephone number each time.

Therefore, if display to the effect that a comment and an impression can be accepted is provided and an e-mail address is displayed in a TV broadcast program, its image can be captured to acquire the e-mail address displayed in the captured image through character recognition so that comments or impressions on the program can be transmitted to a target partner. Therefore, the user need not take notes of the e-mail address or manually input the e-mail address, thereby preventing occurrence of a mistake in inputting of the e-mail address.

Similarly, if a URL or a telephone number is contained in a displayed image, its image can be captured to acquire the URL or the telephone number contained in that captured image through character recognition so that the user can acquire detailed information through a webpage, make phone call for offer of purchase, etc.

Besides, in the above-described first embodiment, it is possible to repeat only image capture processing to manage captured images by using the album function so that they can be utilized later slowly. That is, if an image that need not be utilized immediately but is desired to be utilized later is displayed, the image can be captured and saved as image data so that it may be read and utilized as necessary.

Although in the above first embodiment, a target one of captured images has been selected by using the album function and displayed on the overall display screen 13G and then subjected to character recognition if display location of character information had been indicated, the present invention is not limited to it. For example, character information contained in a displayed image may be recognized by pressing a character recognition direction key provided in the remote commander 100. In this case, image data might as well be analyzed to identify a display area in which the character information is displayed, thus forming pattern matching data from the image data for pattern matching as in the above-described case.

It is also possible to perform character recognition processing on character information contained in a selected image immediately after a target reduced image is selected and use it.

As can be seen from the above, in this first embodiment, the receiving device is illustratively realized by the remote commander 100 and the remote-control signal reception portion 43; the take-in device is illustratively realized by the capture-processing portion 11 and the control portion 20; and the display controller is illustratively realized by the control portion 20, the OSD-processing portion 10, and the synthesis portion 9 in cooperation each.

Further, each of the list-display-receiving device and the selection-input-receiving device is illustratively realized by the remote commander 100 and the remote-control signal reception portion 43 or the touch panel 14 and the coordinate conversion portion 15; and each of the list-display-processing device and the image-display-processing device is illustratively realized by the control portion 20, the D/A conversion portion 6, the selector 4, the main-video-processing portion 7, etc. The execution-direction-receiving device is illustratively realized by the remote commander 100 and the remote-control signal reception portion 43 or the touch panel 14 and the coordinate conversion portion 15; the character recognition device is mainly realized by the control portion 20; and the communication-related processing device is illustratively realized by the control portion 20 and the communication portion 30.

### Second Embodiment

As described above, a TV receiver of the first embodiment has captured an image containing necessary display information and accumulated it as image data, which captured image can be displayed and utilized any time when necessary, by utilizing an album function.

However, there is such a case where it is necessary to utilize a captured image immediately. Especially in a case where information that identifies a communication partner such as e-mail address, URL, or a telephone number is contained in the display information, it is sometimes desired to immediately transmit e-mail to that partner, access a web page identified by the URL to confirm detailed information, or make phone call to the partner for communication.

To accommodate it, when having captured a video such as a TV broadcast program, a TV receiver of this second embodiment, without using the album function, immediately recognizes a character string contained in the captured image in response to a direction from a user, to automatically activate e-mail software or a browser in accordance with the recognized character string so that it can be utilized.

It is to be noted that the TV receiver of this second embodiment has the same configuration as that of the above-described first embodiment as shown in FIG. 1. Therefore, the TV receiver of this second embodiment has also such a configuration as shown in FIG. 1 and a remote commander equipped with such operation keys as shown in FIG. 2 can be used, so that it is described below with reference to FIGS. 1 and 2 also.

Further, the TV receiver of this second embodiment has also four basic operations modes of the TV mode, the Internet mode, the e-mail mode, and the telephone mode as in the case of the TV receiver of the above-described first embodiment and is equipped with roughly the same functions as the TV receiver of the first embodiment. However, a screen memo function of the TV receiver of this second embodiment is different from that of the TV receiver of the above-described first embodiment as mentioned below.

[Utilization of Screen Memo Function]

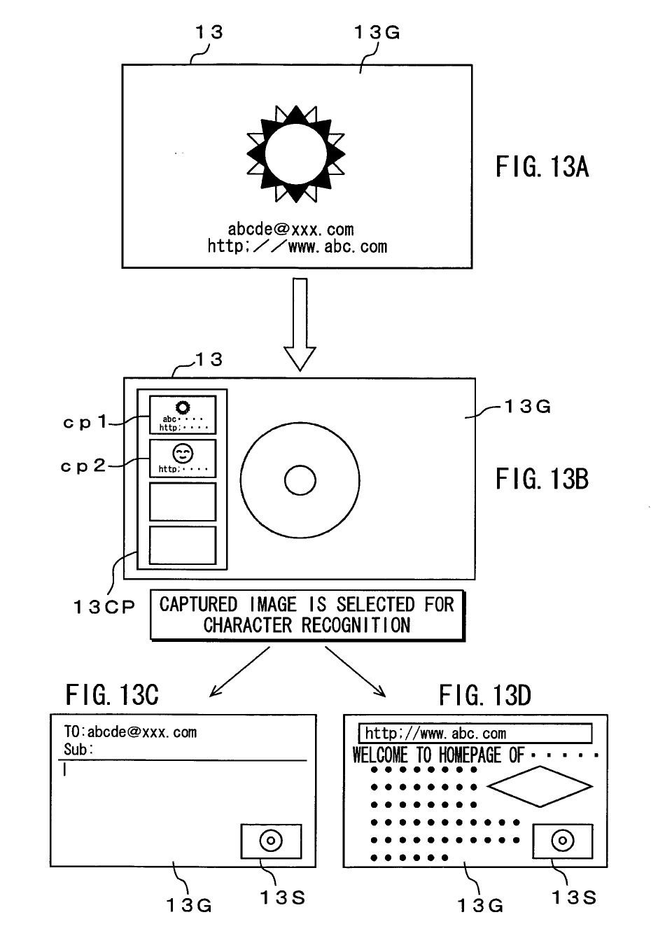

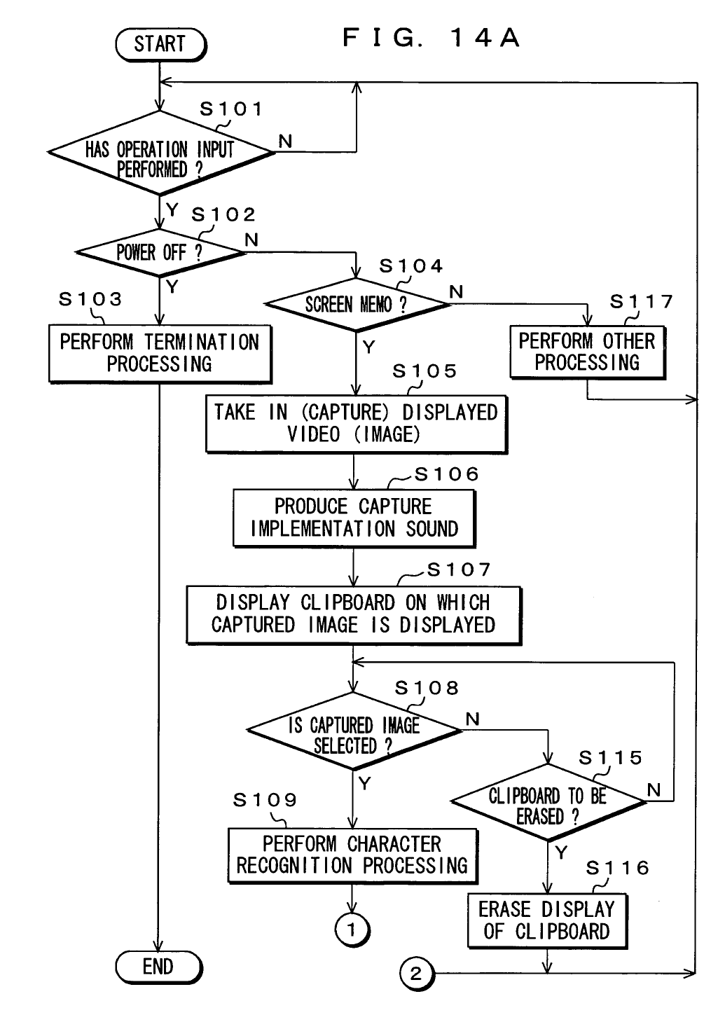

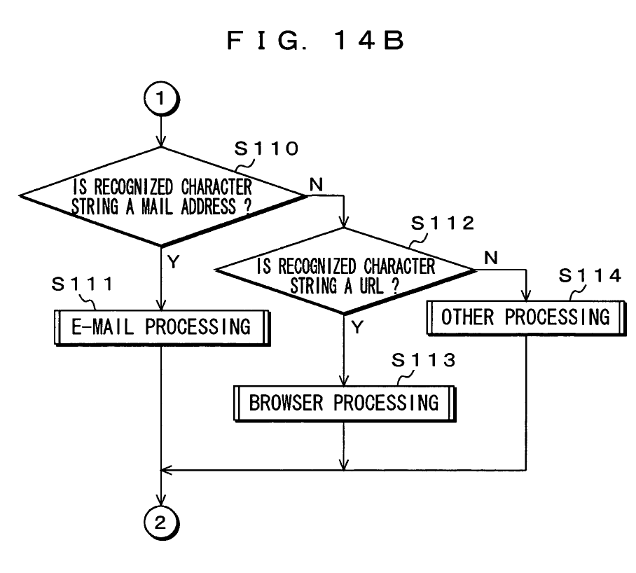

FIGS. 13A-13D are explanatory illustrations of the screen memo function in the TV receiver of this second embodiment. The TV receiver of this second embodiment can also display a TV broadcast program image, an externally input image, a Web page image, an e-mail screen, etc. on a display screen of a display portion 13 and take in (capture) one screen of those displayed images (videos) as image data.

For example, in a case where a TV broadcast program image (video) containing an e-mail address or a URL is displayed on a display screen 13G of the display portion 13 as shown in FIG. 13A, if a user presses a screen memo key 108 on a remote commander 100, the corresponding remote control signal is sent from the remote commander 100 and received by a remote-control signal reception portion 43 of the TV receiver of this second embodiment.

In this case, a control portion 20 in the TV receiver controls a capture-processing portion 11 so that a video signal for forming an image displayed on the display screen 13G of the display portion 13 may be taken in as image data and recorded as an image file in an external memory 50 mounted to itself. In this case, the control portion 20 controls an audio-signal-processing portion of an audio signal system, not shown, so that an alarm sound indicating that a displayed image is captured can be produced by a speaker equipped to the TV receiver of the present embodiment.

Furthermore, the control portion 20 supplies an OSD-processing portion 10 with image data that forms a reduced image of the most recently captured image and image data that forms reduced images of the most recent three images of those captured previously, to display a clipboard 13CP on which the reduced images of the captured images are displayed, on the left side in the display screen 13G, as shown in FIG. 13B.

In the case of FIG. 13B, two captured images of reduced image cp1 of the most recently (this time) captured video and reduced image cp2 of the previously captured image are displayed on the clipboard 13CP. That is, an example of FIG. 13B shows a case where two images are captured by the screen memo function.

In the TV receiver of this second embodiment, until a constant lapse of time (e.g., about 10 seconds) elapses from display or until a function key 109 on the remote commander 100 is pressed, the clipboard 13CP remains as displayed. If a location on the display screen 13G on which a reduced image of a captured image displayed on the clipboard 13CP is displayed is touched by a finger etc., this touched location is posted through a touch panel 14 and a coordinate conversion portion 15 to the control portion 20, upon which the control portion 20 decides that the captured image is selected.

If it decides that the captured image has been selected, the control portion 20 recognizes character information contained in the captured image.

If the character information displayed on the captured image thus selected is recognized by this character recognition to be an e-mail address, the control portion 20 automatically activates e-mail software to display an e-mail creation screen to use the e-mail address obtained by character recognition as an e-mail address of a target partner, thereby enabling e-mail to be created and transmitted, as shown in FIG. 13C.

In this case, a sub screen 13S is provided at the right bottom of the display screen 13G as shown in FIG. 13C, to display here an image to be displayed on the overall display screen 13G at a stage of FIG. 13A. With this, even in a case where the e-mail software is activated to display the e-mail creation screen on the overall display screen 13G as shown in FIG. 13C, a video of a TV broadcast program that has been viewed up to that time can be watched continuously on the sub screen 13S provided at a portion of that display screen 13G.

In this case, sound (of the TV broadcast program) synchronized with the video displayed on the sub screen can be broadcast to continue viewing of various contents that have been viewed up to that time. It is to be noted that to display an image, a video signal that forms the e-mail creation screen from the control portion 20 can be supplied to a main-video-processing portion 7 so that a video signal from a demodulation portion 3 or an input terminal 5 that has been viewed up to that time may be supplied to a sub-screen-processing portion 8.

Similarly, if the character information displayed on the captured image thus selected is recognized by character recognition to be a URL, the control portion 20 automatically activates a browser to access a Web page identified by the URL obtained by the character recognition so that information provided as the Web page may be acquired, as shown in FIG. 13D.

In this case also, the sub screen 13S is provided at the right bottom of FIG. 13D, to display here an image to be displayed on the overall display screen 13G at a stage of FIG. 13A. With this, even in a case where the browser is activated to display the Web page on the overall display screen 13G as shown in FIG. 13D, an image that has been viewed up to that time can be watched continuously on the sub screen 13S provided at a portion of that display screen 13G.

It is to be noted that in the TV receiver of this second embodiment, each time the screen memo key 108 is pressed, a capture implementation sound is produced from a speaker of the TV receiver and the clipboard 13CP on which a reduced image of the most recently captured image is located at its upper side is displayed.

In the case of the TV receiver of this second embodiment, as described above, a captured image can be utilized immediately, thus accommodating such a case that it is desired to immediately start communication processing by using information that identifies a communication partner contained in the captured image.

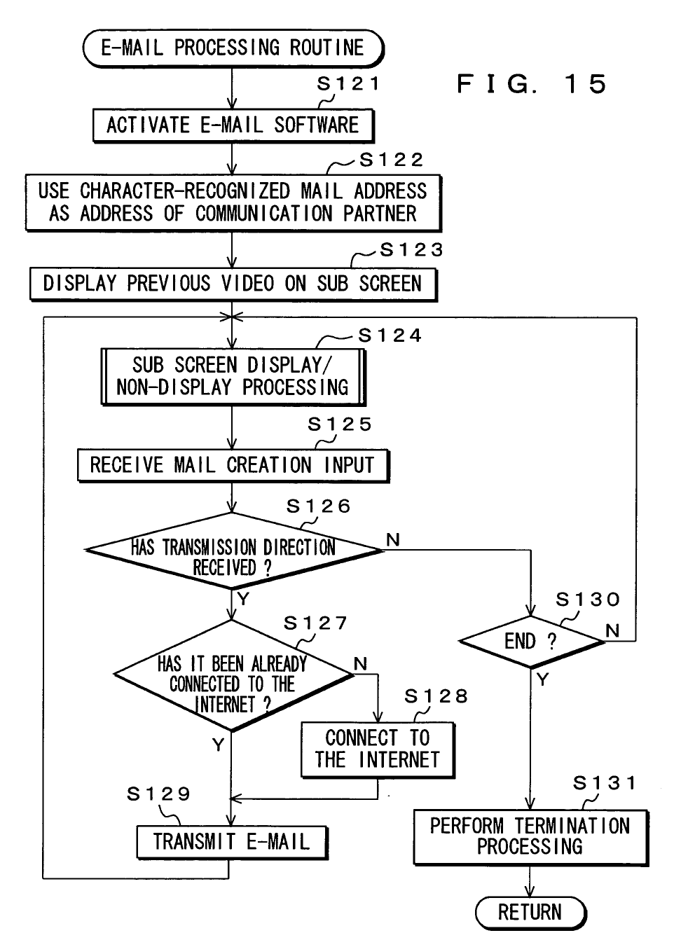

The following will describe operations of the TV receiver of this second embodiment mainly when the screen memo function is implemented, with reference to FIGS. 14A and 14B. FIGS. 14A and 14B are explanatory flowcharts of processing performed by the control portion 20 upon power application of the TV receiver of this second embodiment.

When power is applied, the control portion 20 of the TV receiver of the present embodiment waits for an operation input from the user (step S101). The control portion 20 decides, through the remote-control signal reception portion 43 or the touch panel 14, whether an operation input from the user is received. If it is decided not so at step S101, the process repeats processing starting from step S101 and, otherwise, decides whether the received operation input directs to turn off power (step S102).

If such is the case, the control portion 20 performs end processing to stop supply of power to the portions for example (step S103) to end the processing shown in FIGS. 14A and 14B. Otherwise, the control portion 20 decides whether the received operation input directs to implement the screen memo function (step S104).

If such is the case, the control portion 20 controls the capture-processing portion 11 so that a video signal that forms a displayed video may be recorded as digital data in a predetermined memory, here the external memory 50 attached to the TV receiver (step S105).

In this case, the control portion 20 controls a sound-signal-processing portion, not shown, in the TV receiver to produce an alarm sound notifying a user of capture of the video through the speaker (step S106) and supply the OSD-processing portion 10 with data for displaying reduced images of a plurality of captured images to be displayed on the clipboard 13CP so that the clipboard 13CP may be displayed for a constant lapse of time on which the reduced images of the plurality of captured images is displayed (step S107). In processing of step S107, after the clipboard 13CP is displayed, the control portion 20 decides whether an image in the captured image(s) displayed on the clipboard 13CP is selected by the user (step S108).

If it is decided at step S108 that the captured image is selected, the control portion 20 analyzes image data of the selected image to identify a display area in which character information is displayed, form matching data for performing pattern matching from the image data of an image displayed in that display area, perform pattern matching between this formed matching data and matching data of a character prepared in the ROM22 in the control portion 20 beforehand to recognize the character, encode the recognized character into character data, and store and hold it in, for example, the EEPROM24 (step S109). After processing of this step S109, the control portion 20 goes to step 110 for decision processing shown in FIG. 14B, to decide whether the character-recognized display information is an e-mail address (step S110).

If it is decided at step S110 that the recognized character string is an e-mail address, the process performs e-mail processing (step S111) and, after this, repeats the processing starting from step S101 shown in FIG. 14A. If it is decided otherwise at step S110, the control portion 20 decides whether the recognized character string is a URL (step S112).

If such is the case, it performs browser processing (step S113) and repeats the processing starting from step 101 shown in FIG. 14A. If it is decided at step S112 that the character-recognized information is not a URL, on the other hand, the control portion 20 performs other processing (step S114) and repeats the processing starting from step S101 shown in FIG. 14A. It is to be noted that the other processing performed at step S114 shown in FIG. 14B is the same as the other processing performed in the TV receiver of the first embodiment described with reference to FIG. 12.

Further, if it is decided at step S108 shown in FIG. 14A that the captured image is not selected, the process decides whether a clipboard erasure cause such that a constant lapse of time has elapsed since start of display of the clipboard 13CP or a direction for erasure of the clipboard 13Cp is received from the user has occurred (step S115).

If it is decided at step S115 that the clipboard erasure cause has occurred, it erases display of the clipboard 13CP (step S116) and repeats the processing starting from step S101. Otherwise, it repeats the processing starting from step S108.

Further, if it is decided at step S104 that the received operation input does not direct implementation of the screen memo function, the control portion 20 performs other processing in accordance with the received operation input, for example, selection of a broadcast channel, adjustment of a sound volume, adjustment of a picture quality, mode switching, etc. (step S117). After the processing of step S117, the control portion 20 repeats the processing starting from step S101, to wait for an operation input from the user.

In such a manner, in the TV receiver of this second embodiment, if a displayed video is captured, a capture image is selected through reduced images of captured images displayed on the clipboard 13CP, to recognize character information contained in the selected capture image so that communication processing can be performed quickly by using the character information.

[Post-Character Recognition Processing]

The following will describe e-mail processing performed at step S111 and browser processing performed at step S113 in a case where a character is recognized in processing of the screen memo function shown in FIGS. 14A and 14B.

[E-mail Processing]

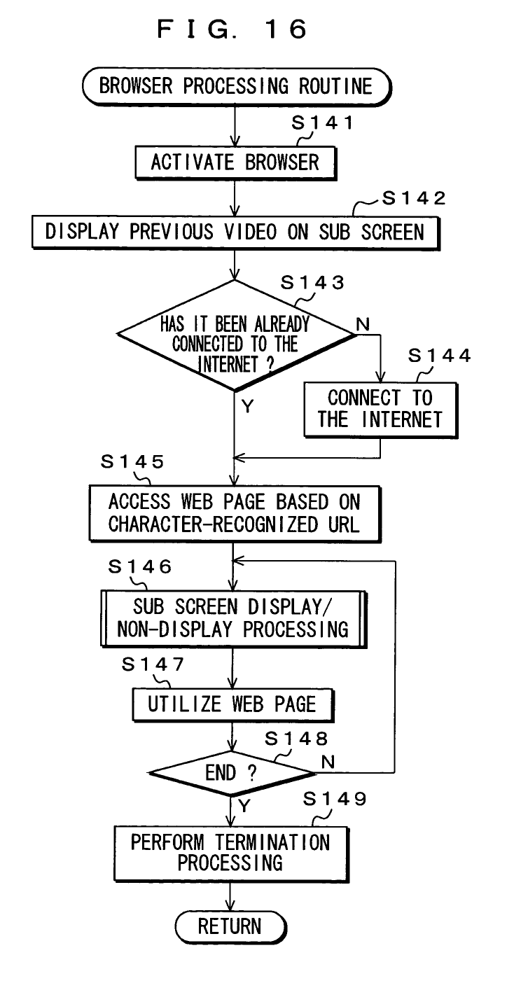

FIG. 15 is an explanatory flowchart of e-mail processing performed at step S111 shown in FIG. 14B. That is, if a recognized character string is decided to be an e-mail address, the control portion 20 performs processing shown in FIG. 15, to first activate e-mail software (step S121) to display the e-mail creation screen and automatically set the e-mail address thus obtained by character recognition to be used as a destination address (step S122) to start display on the sub screen 13S a video set to be displayed on the overall display screen before the display of the e-mail creation screen (step S123).

Then, as described later also, the process performs sub screen display/non-display processing for receiving an input of directing display/non-display of the sub screen 13S (step S124), to receive an e-mail creation input (step S125).

It decides whether it is directed to transmit the created e-mail (step S126) and, if such is the case, decides whether connection to the Internet has been established (step S127). If it is decided at step S127 that connection to the Internet has not yet been established, the control portion 20 performs processing to connect to the Internet through a predetermined ISP (step S128).

If it is decided at step S128 that connection to the Internet has already been established or if processing at step S128 is performed to establish connection to the Internet, the control portion 20 transmits the created e-mail to a destination server with mail-box functions that is specified by the recognized e-mail address (step S129). Then, it returns to the processing starting from step S124, to continue creation of e-mail.

If it is decided at step S126 that transmission is not directed, the process decides whether it is directed to end the processing (step S130). If it is decided at step S130 that it is not directed to end the processing, the control portion 20 repeats the processing starting from step S124. Otherwise, the control portion 20 performs termination processing to end the e-mail software etc. (step S131), to end the processing shown in FIG. 15.

It is thus possible to create e-mail by automatically using a recognized e-mail address as an address to which the e-mail is to be transmitted, thus transmitting the created e-mail. Therefore, the user can activate the e-mail software to create e-mail and transmit it to a target partner without manually inputting an e-mail address of the target partner.

Besides, it is possible for a user to watch on the sub screen 13S a video such as, for example, a TV broadcast program or contents from an external device to be displayed on the overall display screen 13G until the e-mail creation screen is displayed. That is, even in a case where the screen memo function is used to capture an image so that the captured image can be utilized immediately, it is possible for the user to continuously view an image that has been viewed, on the sub screen 13S.

[Browser Processing]

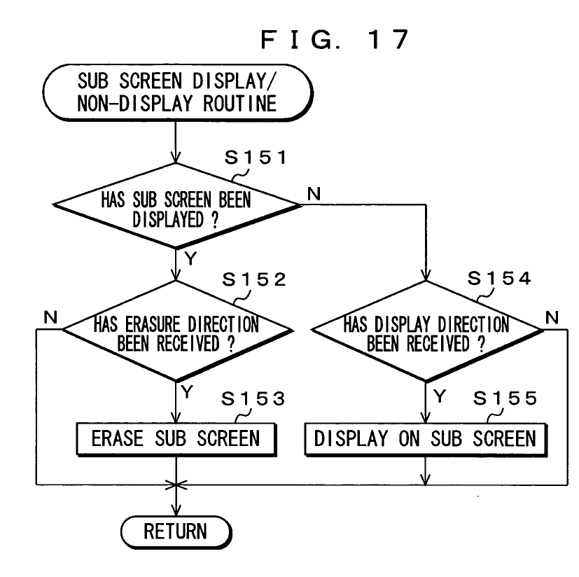

FIG. 16 is an explanatory flowchart of browser processing performed at step S113 shown in FIG. 14B. That is, if a recognized character string is decided to be a URL, the control portion 20 activates a browser (step S141) to give display information corresponding to the browser on the overall display screen 13G so that displaying on the sub screen 13S an image displayed on the overall display screen 13G before display of this display information corresponding to the browser on the overall display screen 13G may be started (step S142).

Then it decides whether connection to the Internet has been established (step S143). If it is decided at step S143 that connection to the Internet has not yet been established, the control portion 20 performs processing to connect to the Internet through, for example, a predetermined ISP (step S144).

If it is decided at step S143 that connection to the Internet has already been established or if processing at step S144 is performed to establish connection to the Internet, it automatically accesses a Web page identified by a URL acquired through character recognition to display the Web page on the display screen 13G (step S145).

Then, as described later also, it performs sub screen display/non-display processing to receive an input of directing the sub screen 13S to be displayed or not to be displayed (step S146), thus enabling utilization of the Web page (step S147). The Web page can be utilized variously, for example, to scroll it in order to obtain necessary information or print its contents.

The process decides whether termination is directed (step S148) and, if it is decided not so, repeats the processing starting from step S146. If it is decided at step S148 that termination is directed, the control portion 20 performs termination processing to terminate the browser (step S149), to end the processing shown in FIG. 16.

It is thus possible to access a target Web page by using a recognized URL. Therefore, the user can activate a browser to automatically access a target Web page without manually inputting a URL of the target Web page.

It is also possible for a user to watch on the sub screen 13S a video such as, for example, a TV broadcast program or contents from an external device that has been displayed on the overall display screen 13G until the browser screen is displayed. That is, even in a case where the screen memo function is used to capture an image so that the captured image can be utilized immediately, it is possible for the user to continuously view an image that has been viewed, on the sub screen 13S.

[Sub Screen Display/Non-Display Processing]

FIG. 17 is an explanatory flowchart of sub screen display/non-display processing performed at step S124 of FIG. 15 and step S146 of FIG. 16. In the e-mail processing shown in FIG. 15 and the browser processing shown in FIG. 16, as described above, a video such as a TV broadcast program that has been displayed immediately before the e-mail creation screen or the browser screen is displayed is displayed on the sub screen 13S.

However, display of the sub screen 13S may be a hindrance in some cases. Therefore, in the TV receiver of this second embodiment, the user can switch between display/non-display of the sub screen 13S.

That is, in the sub screen display/non-display processing performed at step S124 of FIG. 15 and at step S146 of FIG. 16, the control portion 20 first decides whether the sub screen 13S has been displayed (step S151). This decision can be made from a control state of the selector 4 or the sub-screen-processing portion 8.

If it is decide at step S151 that the sub screen 13S has been displayed, the control portion 20 decides through the remote commander 100 or the touch panel 14 whether a predetermined operation to direct erasure of the sub screen 13S is received (step S152).

If it is decided so at step S152, the control portion 20 controls, for example, the selector 4 and the sub-screen-processing portion 8 not to display the sub screen 13S (step S153), thus ending the processing shown in FIG. 17. If it is decided not so at step S152, on the other hand, the control portion 20 ends the processing shown in FIG. 17 while continuing to display the sub screen 13S.

Further, if it is decided at step S151 that the sub screen 13S has not yet been displayed, the control portion 20 decides through the remote commander 100 or the touch panel 14 whether a predetermined operation to direct display of the sub screen 13S is received (step S154).

If it is decided so at step S154, the control portion controls, for example, the selector 4 and the sub-screen-processing portion 8 to supply the sub-screen-processing portion 8 with a video signal from the demodulation portion 4 that has been viewed on the sub screen 13S or a video signal from the input terminal 5 in order to display a video on the sub screen (step S155) and ends the processing shown in FIG. 17. If it is decided not so at step S154, on the other hand, the control portion 20 ends the processing shown in FIG. 17 while erasing display of the sub screen 13S.

In such a manner, in the case of the TV receiver of this second embodiment, if a captured image can be utilized immediately which contains character information (display information) that identifies a communication partner such as an e-mail address, a URL, or a telephone number, it is possible to recognize the character information and, based on this recognized character information, create e-mail and transmit it, access a Web page to display its information, or make phone call for communication.

Even in a case where e-mail is to be created or a Web page is to be viewed, it is possible for a user to view on the sub screen 13S a video of a TV broadcast program or contents from an external device that has been viewed up to that time, thus preventing occurrence of such a trouble that an importance scene is missed. Further, since the user himself can switch between display/non-display of the sub screen 13S, if the sub screen 13S is a hindrance against creation of e-mail or viewing of a Web page, display of the sub screen 13S is erased and, if it is not a hindrance any more or as necessary, the sub screen 13S is displayed.

Although it has been described that, in the above second embodiment, to select a target reduced image from the clipboard 13CP, character information contained in that selected image is recognized, the present invention is not limited to it. For example, to select the target reduced image from the clipboard 13CP, that selected reduced image can be displayed as expanded on the overall display screen 13G and then subjected to character recognition when a character-recognition implementation direction is given as in the case of the first embodiment.

Further, as is clear from the above second embodiment, in this second embodiment, the receiving device is illustratively realized by the remote commander 100 and the remote-control signal reception portion 43; the take-in device is illustratively realized by the capture-processing portion 11 and the control portion 20; and the display-processing device is illustratively realized by the control portion 20, the OSD-processing portion 10, and the synthesis portion 9.

Further, the selection-input-receiving device is illustratively realized by the remote commander 100 and the remote-control signal reception portion 43 or the touch panel 14 and the coordinate conversion portion 15; the character recognition device is mainly realized by the control portion 20; and the communication-related processing device is illustratively realized by the control portion 20 and the communication portion 30. Further, subsidiary image-display-processing device is illustratively realized by the control portion 20, the selector 4, and the sub-screen-processing portion 8.

Although, in the above first and second embodiments, a display image of one screen has been captured, the present invention is not limited to it; for example, in a case where a Web page is displayed, for example, if a plurality of images is present in the image of one screen and can be individually identified and selected, of course, an input for selecting a target one of the images can be received to capture only that selected image and pasted to the clipboard.

Although the first and second embodiments have been described with a case where the present invention is applied to a TV receiver that receives and channel-selects an analog TV broadcast signal of a surface wave, the present invention is not limited to it. The present invention can be applied also to a TV receiver that has a satellite broadcast reception function, a TV receiver that has a data broadcast reception function, and a TV receiver that has a cable TV broadcast reception function. Further, the present invention is applicable to a TV receiver that has two or more of these reception functions.

Further, the above second embodiment has been described with a case where a sub screen can be provided on a parent screen with a so-called PinP function being installed. In this case, a location of the sub screen is not limited to that of the above-described example but may be appropriate one or can be changed by the user.

It is also possible to provide various types of two-screen display to accommodate a so-called picture-out-of-picture (PoutP) system so that the parent and sub screens may not overlap with each other in display area or to display different images on right and left or upper and lower divided portions of the display screen of the display portion 13.

Although the above first and second embodiments have been described with a case where the present invention is applied to a TV receiver, the present invention is not limited to it. For example, the present invention can be applied also to a receiver referred to as a set-top box (STB), which is a cable TV broadcast receiver or a receiver referred to as an integrated receiver/decoder (IRD).

To implement such a configuration, the telephone circuit that provides the receiver with a communication function, the sub-screen-processing portion or the video synthesis portion that realizes the two-screen function, and the capture-processing portion can be mounted to install various necessary programs such as a program for performing character recognition processing. With this, in the receiver, videos can be captured and subjected to two-screen processing so that thus processed video signals may be supplied to a monitor receiver.

It is thus possible to control the receiver while watching the video displayed on the display screen of the monitor receiver, to take in as still images such video images as to contain character information that identifies a communication partner as display information, detect the character information contained in this taken-in video, and use this detected information for communication.

Similarly, the present invention can be applied to a video signal reproducer for reproducing a video signal recorded on a recording medium such as a VCR or a DVD. In this case, it is possible to take in a video signal that forms such a video of one screen displaying information that indicates a communication partner of those displayed by the reproduced video signal and recognize and extract this character information that indicates the communication partner displayed by the taken-in video signal and utilize it for communication processing.

Further, it is possible to accumulate information that identifies a communication partner detected by character recognition in, for example, an EEPROM so that thus accumulated information may be used as an address book. Further, it is also possible to register URLs detected by character recognition as those that are used in a browser function of a bookmark or a favored function so that they can be utilized. Further, information that indicates the communication partner is not limited to a telephone number, an e-mail address, or a URL but may be a postcode, an address, or any other postal information that identifies the communication partner.

While the foregoing specification has described preferred embodiment (s) of the present invention, one skilled in the art may make many modifications to the preferred embodiment without departing from the invention in its broader aspects. The appended claims therefore are intended to cover all such modifications as fall within the true scope and spirit of the invention.

1. An apparatus for processing an image, said apparatus comprising:
receiving device for receiving an input to direct take-in of the image displayed on a display screen;
take-in device for, if the input to direct the take-in is received through the receiving device, taking in as digital data in a memory an image signal that forms the image of one frame displayed on the display screen; and
display-processing device for, if the digital data is recorded in the memory, processing a display of a reduced image of an image corresponding to the currently recorded digital data and at least one reduced image of an image corresponding to the digital data recorded in the memory in the past for a predetermined lapse of time at one portion on the display screen.

2. The apparatus according to claim 1, further comprising:
list-display-direction-receiving device for receiving an input of directing to display a list of the respective reduced images of a plurality of images taken into the memory on the display screen;
list-display-processing device for, if the input of directing to display the list is received through the list-display-direction-receiving device, displaying a list of the respective reduced images of a plurality of images stored in the memory;
selection-input-receiving device for receiving an input of selecting a target reduced image from those reduced images listed on the display screen by the list-display-processing device; and
image-display-processing device for processing an image display to expand the target reduced image selected by the selection-input-receiving device to display the target image thus expanded on the display screen.

3. The apparatus according to claim 2, further comprising:
execution-direction-receiving device for receiving a direction to execute recognition processing on character information contained in the image that is displayed as expanded on the display screen by the image-display-processing device;
character recognition device for performing character recognition on the character information contained in the image that is displayed as expanded on the display screen if the execution direction is received by the execution-direction-receiving device; and
communication-related processing device for performing communication-related processing in accordance with the character information recognized by the character recognition device if this character information indicates a communication partner.

4. An apparatus for processing an image, said apparatus comprising:
receiving device for receiving an input to direct take-in of the image displayed on a display screen;
take-in device for, if the input to direct the take-in is received through the receiving device, taking in as digital data in a memory an image signal that forms the image of one frame displayed on the display screen;
display-processing device for, if the digital data is recorded in the memory, displaying a reduced image of an image corresponding to the currently recorded digital data and at least one reduced image of an image corresponding to the digital data recorded in the memory in the past at one portion on the display screen;
selection-input-receiving device for receiving an input of selecting a target reduced image from those reduced images that are displayed by the display-processing device;
character recognition device for recognizing character information displayed in the target reduced image that is selected through the selection-input-receiving device; and
communication-related processing device for performing communication-related processing in accordance with the character information recognized by the character recognition device if this character information indicates a communication partner.

5. The apparatus according to claim 4, further comprising subsidiary image-display-processing device for, if an image in accordance with the communication-related processing performed by the communication-related processing device is displayed on the display screen, displaying an image corresponding to an image signal that has displayed the image on the display screen up to that time, at one portion on the display screen.

6. A method for processing an image, said method comprising:
a reception step of receiving an input to direct take-in of the image displayed on a display screen;
a take-in step of, if the input to direct the take-in is received at the reception step, taking in as digital data in a memory an image signal that forms the image of one frame displayed on the display screen;
a display-processing step of, if the digital data is recorded in the memory, displaying for a predetermined lapse of time a reduced image of an image corresponding to the currently recorded digital data and at least one reduced image of an image corresponding to the digital data recorded in the memory in the past, at one portion on the display screen.

7. The method according to claim 6, comprising:
a list-display-direction-receiving step of receiving an input of directing to display a list of the respective reduced images of a plurality of images taken into the memory on the display screen;
a list-display-processing step of, if the input of directing to display the list is received at the list-display-direction-receiving step, displaying a list of the respective reduced images of a plurality of images stored in the memory;
a selection-input-receiving step of receiving an input of selecting a target reduced image from those reduced images listed on the display screen at the list-display-processing step; and
an image-display-processing step of processing an image display to expand the target reduced image selected at the selection-input-receiving step to display the target image thus expanded on the display screen.

8. The method according to claim 7, comprising:
an execution-direction-receiving step of receiving a direction to execute recognition processing on character information contained in the image that is displayed as expanded on the display screen at the image-display-processing step;
a character recognition step of performing character recognition on the character information contained in the image that is displayed as expanded on the display screen if the execution direction is received at the execution-direction-receiving step; and
a communication-related processing step of performing communication-related processing in accordance with the character information recognized at the character recognition step if this character information indicates a communication partner.

9. A method for processing an image, said method comprising:
a reception step of receiving an input to direct take-in of the image displayed on a display screen;
a take-in step of, if the input to direct the take-in is received at the reception step, taking in as digital data in a memory an image signal that forms the image of one frame displayed on the display screen;
a display-processing step of, if the digital data is recorded in the memory, displaying a reduced image of an image corresponding to the currently recorded digital data and at least one reduced image of an image corresponding to the digital data recorded in the memory in the past, at one portion on the display screen;
a selection-input-receiving step of receiving an input of selecting a target reduced image from those reduced images that are displayed at the display-processing step;
a character recognition step of recognizing character information displayed in the target reduced image that is selected at the selection-input-receiving step; and
a communication-related processing step of performing communication-related processing in accordance with character information recognized at the character recognition step if this character information indicates a communication partner.

10. The method according to claim 9, further comprising a subsidiary-image-displaying step of, if an image in accordance with the communication-related processing performed at the communication-related processing step is displayed on the display screen, displaying an image corresponding to an image signal that has displayed the image on the display screen up to that time, at one portion on the display screen.
